(19) United States
(12) Patent Application Publication
(10) Pub. No.: US 2025/0315834 A1
(43) Pub. Date: Oct. 9, 2025

(54) MONEY MULE DETECTION USING LINK PREDICTION

(71) Applicant: ACTIMIZE LTD., Ra'anana (IL)

(72) Inventors: Shubhanshu SHARMA, Greater Noida (IN); Kushal EDWANKAR, Pune (IN); Anurag MOHAPATRA, Livingston, NJ (US)

(21) Appl. No.: 18/629,309

(22) Filed: Apr. 8, 2024

(51) Int. Cl. G06Q 20/40; G06N 20/00

(52) U.S. Cl. CPC G06Q 20/4016; G06N 20/00

(57) ABSTRACT

A system is adapted to identify suspected mule accounts. It includes a processor configured to select seed entities, and identify a network of accounts associated with each seed entity. For networks that includes at least one known mule account, the processor computes a similarity score between each pair of accounts and, based on the similarity scores, clusters the accounts, labels the clusters as to whether they are high-mule-rate clusters, and uses the clusters to train a link prediction model. The processor then, in real time, receives a transaction for an entity, identifies a second network of accounts associated with the entity and, with the link prediction model, for each pair of accounts in the second network, computes a mule risk score and, if the score exceeds a second threshold value, adds the accounts in the pair of accounts to a suspected mules list.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to devices, systems, and methods for detecting money mules in a sequence of financial transactions. This money mule detection system has particular, but not exclusive, utility for anti-money-laundering applications.

### BACKGROUND

Money mules have been playing a critical role in providing the financial infrastructure for criminals/fraudsters to launder stolen funds or proceeds of crime. A money mule is someone who transfers or moves illegally acquired money on behalf of someone else through his/her bank account held at the financial institution. Criminals recruit money mules to help launder proceeds derived from online scams and frauds.

For a fraudster/criminal, money generated by crime is difficult to use until the original tainted source of funds can be disguised. The primary objective of the fraudster is to clean the dirty cash or make the money look legitimate, and thus avoid suspicion from law enforcement agencies.

Money mules add layers of distance between the source of victim and crime, obscuring the source of crime which eventually makes recovery of fraudulent money by Financial Institutions (FIs) nearly impossible. This clearly explains why criminals/fraudsters are increasingly relying on money mules to form the logistics network of financial crime.

Some money mules know they've been recruited by fraudsters to funnel fraudulent money through their accounts, but others become money mules without realizing that their activity is benefiting fraudsters. Fraudsters understand that involving more individuals as money mules also poses a human risk. Money mules could make a wrong move and get caught, or money mules may not transfer funds to the fraudster. Recruiting and managing real individuals as money mules to move money on the fraudsters' behalf thus involves time, cost, and risk.

For these reasons and others, fraudsters are increasingly using synthetic identities to mule the money themselves. Synthetic identities are created by using a combination of personally identifiable information (PII) to fabricate a person or entity. These identities are easy to create on a large scale, given the availability of stolen data on the dark web. In this case, criminals have more control over the funds transfer process.

Another big factor that has fueled the rise of money mules is an unprecedented rise in scams or Authorized Push Payment (APP) Fraud. APP scamming is a form of fraud wherein the victim is tricked into making bank transfers to an account that the victim thinks is legitimate but that could be a mule account.

Money-Mules are one of the top 5 fraud threats that FIs are facing today. The financial institutions are required to not only detect the possibility of the usage of a customer's account in laundering fraudulently acquired money, but also to unveil these chains of accounts that operate together, or in a similar fashion. Detection of these accounts makes it easier for the fraud investigator to decide on the group of accounts while also making it economically difficult for the fraudsters to use multiple accounts for laundering money.

It has been estimated that between 1% and 3% of bank accounts in the US were opened using synthetic identities. Based on this estimate, upwards of 2.5 million synthetic identities could be hiding in U.S. bank accounts, which can potentially generate 3 billion U.S. dollars (USD) in fraudulent transfers per year. By current estimates, approximately 59% of new account fraud is mule-related, and the majority of these accounts demonstrate mule characteristics within 45 days. New Account Fraud means accounts opened by fraudsters using synthetic or stolen identities, which are then used to perpetrate fraud within the first 90 days of account opening.

Apart from just fraud losses, money laundering by money mules has a large impact on society, by allowing drug traffickers, smugglers, and other criminal to expand operations. This can damage financial sector institutions that are critical for economic growth. As per Europol, 2469 mules were arrested in a recent worldwide crackdown against money laundering. Often, the fraudsters operate multiple mule accounts in a chain to launder money. These accounts can operate as large-scale mule rings, and FIs may be completely unaware that their accounts are being used for such fraudulent activity. As a result, approximately 33% of bank executives believe they don't have the necessary tools to control money mule activity.

The financial institutions are required to not only detect the possibility of the usage of a customer's account in laundering fraudulently acquired money, but also to unveil these chains of accounts that operate together, or in a similar fashion. Detection of these accounts makes it easier for the fraud investigator to evaluate a group of accounts, while also making it economically difficult for the fraudsters to use multiple accounts for laundering money. The sooner the financial institutions can identify these mule rings, the lesser the laundering of fraudulent funds through their accounts will be, thus eventually reducing or limiting fraud losses. Thus, a faster and more precise system and method to analyze and detect mule accounts is needed, as disclosed below.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a money mule detection system. The money mule detection system disclosed herein has particular, but not exclusive, utility for anti-money-laundering (AML) applications.

The present disclosure includes a method that can be used to identify the network of banking accounts that are suspected to be part of or formulate a mule ring. The method involves fetching a network of entities, built around an entity that is present in the current transaction that is under detection (e.g., a potentially suspicious entity), and comparing account pairs within the network with a machine learning (ML) model trained on account pairs from a network containing mule accounts. If an account pair is similar to a known mule account pair, the two accounts are added to a suspected mules list.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically identify suspected mule accounts. The system includes a processor and a non-transitory computer readable medium operably coupled thereto, the computer readable medium including a plurality of instructions stored in association therewith that are accessible to, and executable by, the processor, to perform operations which may include: from a plurality of entity types associated with a financial institution, selecting a seed entity type and collecting a plurality of entities of the selected type associated with the financial institution; for each collected entity, considered as a seed entity, from the plurality of entities: identifying a first network of accounts associated with the seed entity, m transaction hops away from the seed entity, and looking at period t in history; if the first network of accounts includes at least one mule account, storing the network. The operations further include, for each network that is stored: computing a similarity score between each pair of accounts in the first network of accounts; based on the similarity scores, clustering the accounts into n clusters; for each cluster: determining a ratio of known mule accounts in the cluster to a total number of accounts in the cluster; if the ratio exceeds a mule account rate threshold value; creating a label identifying the cluster as a mule account cluster; if the ratio does not exceed the mule account rate threshold value; creating the label identifying the cluster as a non-mule account cluster; storing the seed entity, the accounts, cluster id, and the label, into a pre-training dataset. The operations also include: using the pre-training dataset to define a relation between each pair of accounts in the network; labeling each relation between account pairs as either part of a mule ring or not part of a mule ring; with the account pairs and the labels, training a link prediction model using supervised machine learning. The operations also include, in real time: receiving a transaction in a fraud management system for a transaction entity of the plurality of entities associated with the financial institution; identifying a second network of accounts associated with the transaction entity, m transactions hops away from the transaction entity, and looking at period t in history; with the link prediction model, for each pair of accounts in the second network of accounts: computing a link prediction score, representative of a likelihood that the accounts in the pair of accounts are mule accounts; and if the link prediction score exceeds a second threshold value, adding the accounts in the pair of accounts to a suspected mules list. The operations also include displaying the suspected mules list to a user. Other embodiments of this aspect include corresponding computer systems, apparatus, and computer programs recorded on one or more computer storage devices, each configured to perform the actions of the methods.

Implementations may include one or more of the following features. In some embodiments, n is at least 2 and no greater than 6, and m is at least 2 and no greater than 6. In some embodiments, the mule account rate threshold value is at least 50%. In some embodiments, the threshold score for the link prediction machine learning model is at least 70%. In some embodiments, the seed entity is a sending account, a receiving account, a device, an internet protocol (IP) address, a bank branch, a physical address, a sending email, a receiving email, a phone number, a sending person's name, or a receiving person's name. In some embodiments, the transaction entity is a sending account, a receiving account, a device, an internet protocol (IP) address, or a bank branch. In some embodiments, m is at least 2 and no greater than 4. In some embodiments, t is at least 6 months and no greater than 12 months. In some embodiments, the criteria for identifying the first network and the criteria for identifying the second network are the same. Implementations of the described techniques may include hardware, a method or process, or computer software on a computer-accessible medium.

One general aspect includes a computer-implemented method for automatically identifying suspected mule accounts. The computer-implemented method, includes with a processor and a non-transitory computer readable medium operably coupled thereto: from a plurality of entity types associated with a financial institution, selecting a seed entity type and collecting a plurality of entities of the selected type associated with the financial institution; for each collected entity, considered as a seed entity, from the plurality of entities: identifying a first network of accounts associated with the seed entity, m transaction hops away from the seed entity, and looking at period t in history; if the first network of accounts includes at least one mule account, storing the network. The method also includes, for each network that is stored: computing a similarity score between each pair of accounts in the first network of accounts; based on the similarity scores, clustering the accounts into n clusters. The method also includes, for each cluster: determining a ratio of known mule accounts in the cluster to a total number of accounts in the cluster; if the ratio exceeds a mule account rate threshold value; creating a label identifying the cluster as a mule account cluster; if the ratio does not exceed the mule account rate threshold value; creating the label identifying the cluster as a non-mule account cluster; storing the seed entity, the accounts, cluster id, and the label, into a pre-training dataset. The method also includes using the pre-training dataset to define a relation between each pair of accounts in the network; labeling each relation between account pairs as either part of a mule ring or not part of a mule ring; with the account pairs and the labels, training a link prediction model using supervised machine learning. The method also includes, in real time: receiving a transaction in a fraud management system for a transaction entity of the plurality of entities associated with the financial institution; identifying a second network of accounts associated with the transaction entity, m transactions hops away from the transaction entity, and looking at period t in history; with the link prediction model, for each pair of accounts in the second network of accounts: computing a link prediction score, representative of a likelihood that the accounts in the pair of accounts are mule accounts; if the link prediction score exceeds a second threshold value, adding the accounts in the pair of accounts to a suspected mules list. The method also includes displaying the suspected mules list to a user. Other embodiments of this aspect include corresponding computer systems, apparatus, and computer programs recorded on one or more computer storage devices, each configured to perform the actions of the methods.

Implementations may include one or more of the following features. In some embodiments, n is at least 2 and no greater than 6, and m is at least 2 and no greater than 6. In some embodiments, the mule account rate threshold value is at least 50%. The threshold score for the link prediction machine learning model is at between 0.7 and 1.0. In some embodiments, the seed entity is a sending account, a receiving account, a device, an internet protocol (IP) address, a bank branch, a physical address, a sending email, a receiving email, a phone number, a sending person's name, or a receiving person's name. In some embodiments, the transaction entity is a sending account, a receiving account, a device, an internet protocol (IP) address, or a bank branch. In some embodiments, m is at least 2 and no greater than 4. In some embodiments, t is at least 6 months and no greater than 12 months. In some embodiments, criteria for identifying the first network and criteria for identifying the second network are the same. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of hardware components of an example money mule detection system, in accordance with at least one embodiment of the present disclosure.

FIG. 2 is a schematic, diagrammatic representation, in block diagram form, of software components of an example money mule detection system, in accordance with at least one embodiment of the present disclosure.

FIG. 3 is a graphical representation of a network of accounts, entities, and relationships that are associated with an investigated account and investigated entity, in accordance with at least one embodiment of the present disclosure.

FIG. 4 is a graphical representation of at least a portion of a suspected mule ring, in accordance with at least one embodiment of the present disclosure.

FIG. 5 is a schematic, diagrammatic representation, in block diagram form, of an example training data generation process for a money mule detection system, in accordance with at least one embodiment of the present disclosure.

FIG. 6 is a graphical representation of an accounts cluster, in accordance with at least one embodiment of the present disclosure.

FIG. 7 is a schematic, diagrammatic representation, in flow diagram form, of an example money mule detection system training data creation method, in accordance with at least one embodiment of the present disclosure.

FIG. 8 is a schematic, diagrammatic representation, in block diagram form, of an example money mule identification system machine learning model training process, in accordance with at least one embodiment of the present disclosure.

FIG. 9 is a graphical representation of account clusters and edges between accounts in a network, in accordance with at least one embodiment of the present disclosure.

FIG. 10 is a graphical representation of the use of the link prediction machine language model in inference mode, in accordance with at least one embodiment of the present disclosure.

FIG. 11 is a schematic, diagrammatic representation, in block diagram form, of an example inference mode of the money mule detection system, in accordance with at least one embodiment of the present disclosure.

FIG. 12 is a schematic, diagrammatic representation, in block diagram form, of an example inference mode of the money mule detection system, in accordance with at least one embodiment of the present disclosure.

FIG. 13 is a schematic, diagrammatic representation, in flow diagram form, of an example money mule detection method, in accordance with at least one embodiment of the present disclosure.

FIG. 14 is a schematic, diagrammatic representation, in flow diagram form, of an example money mule detection method, in accordance with at least one embodiment of the present disclosure.

FIG. 15 is a schematic, diagrammatic representation, in flow diagram form, of an example money mule detection method, in accordance with at least one embodiment of the present disclosure.

FIG. 16 is a schematic, diagrammatic representation, in flow diagram form, of an example money mule detection method, in accordance with at least one embodiment of the present disclosure.

FIG. 17 is a schematic diagram of a processor circuit, in accordance with at least one embodiment of the present disclosure.

FIG. 18 is a graph showing the number of mule pairs detected as a function of the risk score cutoff, in accordance with at least one embodiment of the present disclosure.

### DETAILED DESCRIPTION

In accordance with at least one embodiment of the present disclosure, a money mule detection system is provided which detects mule accounts and mule rings with high accuracy and a low rate of false positives.

Existing solutions to the problem of money mules vary from simple to complex. The simple solutions include leveraging a risk score from a machine learning (ML) model, trained to predict mule activities, coupled with strategy rules to identify suspicious mule activities on an account. The solution's focus is mainly on tracking specific accounts' behavior for mule activity, but does not provide a way to comprehend a potential mule fraud ring that the account could be part of.

Another solution, of moderate complexity, is querying a network of entities, based on known fraud patterns, which may include potential suspected mule accounts. However, this method can incur a high rate of false positives, if the query to fetch the network of entities is generalized to suit different fraud ring patterns. In the case of specialized queries, the false positives are less, but the identification rate may then be low because of the inability to comprehend complex patterns via a mere querying mechanism.

A complex solution to the problem could involve training a model that learns through the various known mule patterns, and could be used to detect if the given network (or sub-network in the network) is a suspected mule pattern.

The present disclosure includes a method that can be used to identify the network of banking accounts that are suspected to be part of or formulate a mule ring. The method involves fetching a network of entities, built around an entity that is present in the current transaction that is under detection. The network is fetched based on a pre-defined configuration that limits the network size by allowing it to go only n hops away from the central linking/seed entity (or from the current transaction), within t period in history, and employing additional filtering criteria that can be employed to limit the network size. Typically, n will be a value between 2 and 6, and t will be a time period between 3 months and 6 months, although other values both larger and smaller may be used instead or in addition.

The method additionally involves collecting distinct accounts from the fetched network, and creating a vector representation of each by utilizing expert-defined mule risk features (from account/party profiles) and features from the current fetched network. Each pair of account vectors is fed to a function that operates on the given 2 vectors; and returns a new vector that describes the similarity between a given pair of vectors, defined herein as a relation features vector.

The relation features vector is evaluated via the link prediction machine learning (ML) model which returns a probability score (e.g., a probability that the accounts are mule accounts). The score is matched against a pre-determined threshold that suggests whether to classify the given account pairs (whose vectors were used to define relation features vector) as a suspected mule accounts pair.

The process is repeated for each pair of accounts in the network; and identified suspected mule accounts (from the pairs) are maintained in a set. The set is used to derive features for the transaction risk scoring model, and business rules evaluation, and can also be added to an alert, to enable the fraud investigator to validate the existence of a potential mule ring engaging one or multiple entities from the current transaction.

The link prediction model may for example be trained in a lab, using different possible mule networks from a database, with the help of mule labels that are shared by the FI.

For each network fetched, a list of distinct accounts is pulled. Each account in the list is represented in the form of a vector that includes expert-designed mule risk features, and features from the network. The similarity between each pair of accounts in a network is computed (e.g., using cosine similarity), which for example returns a similarity score between 0 and 1, and the similarity scores between each pair of accounts is stored in an accounts similarity matrix.

The accounts similarity matrix is fed to a clustering algorithm, (e.g., k-means clustering), which clusters the accounts together based on their similarity between all other n−1 accounts, where n is the number of accounts in the network. Then the mule account rate is calculated for each cluster, using the labels shared by the FI, and the system assigns a label to each cluster, e.g., 1 if the mule account rate is greater than a threshold, and otherwise 0. It is noted that using this technique can identify other unreported mule accounts that exhibit similar characteristics as known mule accounts (optionally, verified through manual review of cases).

This process is continued for each network and store, the network identifier, the accounts in the network, the cluster they belong to, and the cluster label, to construct the training data set. The system pulls each account pair in the training data set that belongs to the same network; and represents them in the form of vectors using expert-built mule risk features and network features. The list of features used for the account's vectorization could be the same/different/additional to features used during account similarity scoring.

For each account vector pair, the system defines a new vector, e.g., a relation features vector, by operating a function on the given vector pairs. The returned vector may for example be a numeric vector that serves as a data point, which is collected for training a link prediction ML model later. The process continues for each account pair in a network, and then the same procedure for accounts in all networks in the training data set.

The relation features vectors are the data points used for training. The system builds an ML model using this data (e.g., the link prediction model, which may for example be a binary classification model), and for that, it labels each vector. The labeling strategy that may for example be that each vector that defines a relation between a pair of accounts lying in the same cluster with the label as 1 (high mule account rate), is assigned a label 1, else 0.

The model is trained on the labeled relation features vector, and a threshold score is decided based on the appetite for the false positive rate, and the number of mule connections that the model can comprehend at each score step. The link prediction model is deployed to the fraud management system, wherein it is used to determine mule account pairs in a network that includes entities from the transaction that undergo detection (via the same network query/queries as used during network creation in the lab).

The present disclosure employs an analytics solution to the problem of mule ring identification, which is difficult to solve through trivial solutions (e.g., strategy rules, simple network queries). Since the problem requires looking at various risk dimensions when unveiling a potential mule ring, the disclosed technique presents a method that learns through hidden relationships between suspected mule accounts and trains a model that is efficient in linking a group of potential mule accounts.

Compared to writing an expert specialized query for identifying mule patterns, the method disclosed herein encompasses the intricacies of different known mule patterns, and encapsulates them in a single tool, e.g., an ML model. Compared to existing modeling techniques that exist to identify mule patterns, the method disclosed herein incurs fewer false positives, as it operates on the unit link between entities in a network. Merely classifying a sub-graph/network as a suspected mule ring could incur a lot of false positives. The disclosed method also provides an opportunity to identify accounts at fault (suspected mules) in a given network.

The system/method disclosed herein uses multiple statistical models to collect the data, enrich the data by identifying missed mule accounts, and develop an ML model to detect mule account pairs formulating a mule fraud ring. The system provides an opportunity for extending early detection/disruption strategies for money mule frauds using the similarity learning and link prediction technique as described herein. The money mule problem is not siloed to one FI but is faced by FIs globally, so the solution is relevant to a wide range of financial institutions.

Each financial institution today thrives on an opportunity to stop the fraudsters right at the doorstep (in the fraud access stage). The present disclosure enables a business opportunity to deliver an early fraud detection strategy with an in-house solution.

The present disclosure aids substantially in anti-money-laundering operations, by improving methods for identifying mule accounts and mule rings in a timely manner. Implemented on a processor in communication with a number of databases, the money mule detection system disclosed herein provides practical benefits to financial institutions in the form of reduced fraud and its associated costs, as well as a reduction in the effort required to detect and interrupt mule rings. This improved detection process transforms an inquiry into a potentially fraudulent entity, transaction, or event into a list of suspected mule accounts, without the normally routine need to expend large resources of investigator time. This unconventional approach improves the functioning of the fraud investigation computing system, by reducing the amount of machine time and investigator time required to identify a mule ring operating on an FI's accounts.

The money mule detection system may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the money mule detection system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the money mule detection system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

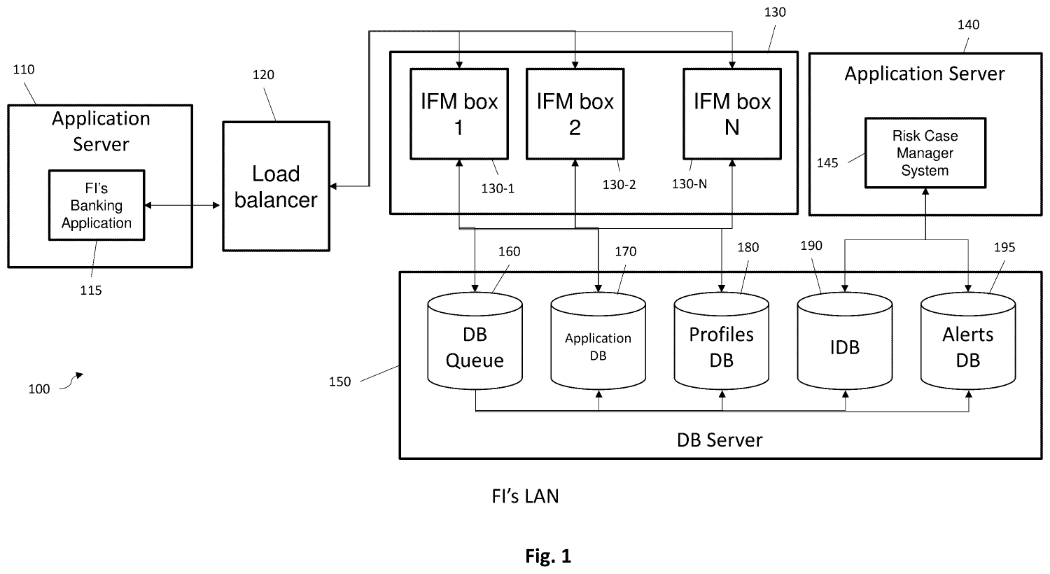

FIG. 1 is a schematic, diagrammatic representation, in block diagram form, of hardware components of an example money mule detection system 100, in accordance with at least one embodiment of the present disclosure. In the example shown in FIG. 1, the money mule detection system 100 includes an application server 110 running the FI's banking application 115. The system 100 also includes a load balancer 120 that receives inputs from Investigation and Fraud Management (IFM) boxes 130-1 through 130-N running on a processor 130, which are in communication with a database server 150. The database (DB) server 150 include a database queue 160, application database 170, profiles database 170, investigation database (IDB) 190, and alerts database 195, any of which may be in mutual communication with one another, and with the processor 130. An application server 140 running a risk case manager system 145 (which may for example include software components of the money mule detection system 100), which exchanges data with the investigation database 190 and alerts database 195.

When an FI's customer performs an action, or there is a transfer activity on an account of a customer, the event is received by the FI's banking application 115. FIs use IFM to assess the risk of the received event. FIG. 1 shows an exemplary hardware setup at the FI's premise for enabling the detection and decision capability on real-time monetary and non-monetary events.

The real-time request originating from the FI's banking application is routed to the load balance component 120, that is used to distribute the request to different IFM boxes/systems 130 that are maintained by the FI. Each IFM box 130 is installed with IFM and runs separate detection processes to serve the incoming requests. A detection process detects the risk of incoming transactions, generates a risk score, generates an alert (if required, depending on the business rules that are set by the FI's fraud strategists), and persists the transaction for future referral.

The risk score and the decision (determined by the business rules) like allow/delay/decline/challenge, for the detected transaction, is returned to the FI's banking application 115 for further perusal by an operator.

An IFM detection process, running on the IFM boxes 130-1 through 130-N, connects with Profile DB 180 and Application DB 170 to enrich the incoming transaction with additional features that are helpful for assessing the transaction.

The detected transaction is added to a DB queue 160 as a part of a synchronous process, and is pulled asynchronously to be persisted in the relevant database's tables.

In case an alert is generated, then an alert is created in the form of a case in the Risk Case Manager System 145, which is managed through a separate database which holds case-related information, the details of which are outside the scope of the present disclosure. The case may also pull transaction-related details from the IDB 190.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described in this disclosure are provided for purposes of illustration, and are not intended to be limiting. Other devices and/or device configurations may be utilized to carry out the operations described herein.

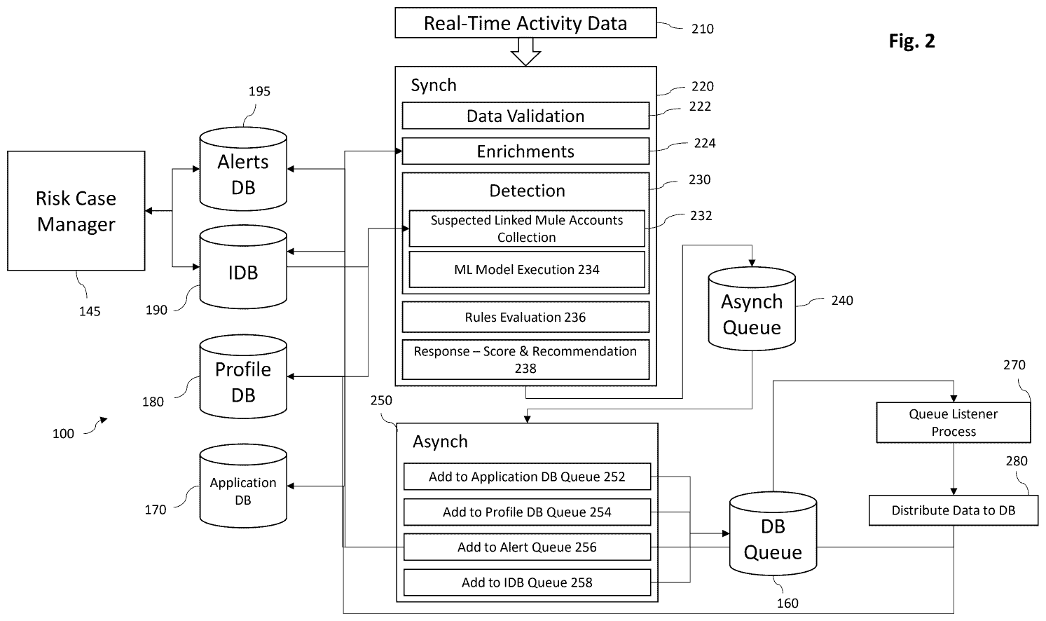

FIG. 2 is a schematic, diagrammatic representation, in block diagram form, of software components of an example money mule detection system 100, in accordance with at least one embodiment of the present disclosure. In the example shown in FIG. 2, real-time activity data 210 is received by synchronous (e.g., real-time) processes 220, which supply data and/or instructions to asynchronous (e.g., near-real time) processes 250 via an asynchronous queue 240.

Synchronous processes include but are not limited to data validation 222, data enrichment 224, and mule detection 230. Mule detection may for example include suspected mule accounts collection 232, ML model execution 234, rules evaluation 236, and response 238 (e.g., providing a risk score and recommendation). Asynchronous operations include but are not limited to adding to the application database queue 252, adding to the profile database queue 254, adding to the alert queue 256, and adding to the IDB queue 258. The DB queue 160 is also overseen by a queue listener process 270 and a process 280 to distribute the added data to the relevant databases 170, 180, 190, 195. The risk case manager application 145 exchanges data with the alerts database 195 and the investigations database 190.

The real-time activity data 210 includes the transactional or current activity information that identifies the type of interaction of the customer with the account, the device used for performing the activity, the funds value requested for transfer (if monetary transaction), etc. The Data Validation block 222 performs the validation of incoming activity data to ensure the fitness of different data elements and ensure the presence of mandatory data elements in the activity to perform successful detection. The enrichment block 224 performs pulling of profiled behavioral data of the customer and recent activities data to identify suspicious activities. The profile DB 180 contains the pre-defined expert features aggregation used for the execution of analytics for detection.

The enrichment block 224 performs the enrichment of the current activity with the data fetched from profile DB 180 and application DB 170, like session-based enrichment (connection ISP, etc.) and customer-beneficiary relationship information.

The suspected linked mule accounts collection block 232 is added per this disclosure. Herein, the system generates a network of entities that are linked to entities in the current transaction. Each account in the network is represented in the form of a features vector, where the features are expert predictive features driven by the profiles, the generated network, and the current transaction, that indicate mule risk. A link prediction ML model evaluates each edge between each pair of accounts in the network; and predicts the probability of the accounts pair to be belonging to a potential mule fraud ring. The pair of accounts attaining high-risk scores by the link prediction model (above the predetermined threshold) are collected in a suspected mule accounts table.

The detection block 230 performs the execution of state-of-the-art machine learning models for generating the risk score for the current activity. The model may choose to check if the current account is present in the suspected mule accounts table, and/or the number of mule accounts in the network with the current account being one of them, etc.

The risk score is added to the current enriched real-time activity and the activity data is passed to the policy manager module for evaluation of the strategy rules that decide on the alerting of the transaction and prescribed next steps based on the strategy rules which are evaluated as affirmative. Herein again, the fraud strategist could opt to employ a rule that checks if the current account is included in the suspected mule table, for instance; and generates an alert accordingly. The transaction risk score along with the indication of alert and prescribed next steps is wrapped in a response 238 and sent back to the source system from where the real-time activity information 210 is passed for detection.

In asynchronous mode, the real-time activity data 210 is added to queues for the profile DB 180, application DB 170, IDB 190, and Alert database 195. The queue listener process dequeues the item from the DB queue 160 and updates the respective databases.

In case an alert is generated for the current transaction, the alert will display the suspected mule accounts in the network of accounts that are connected with the current transaction's entities. The suspected mule accounts will accompany mule risk features and the network features, which were used for the vectorization of the accounts, to aid the investigator in investigating the risk associated with the accounts.

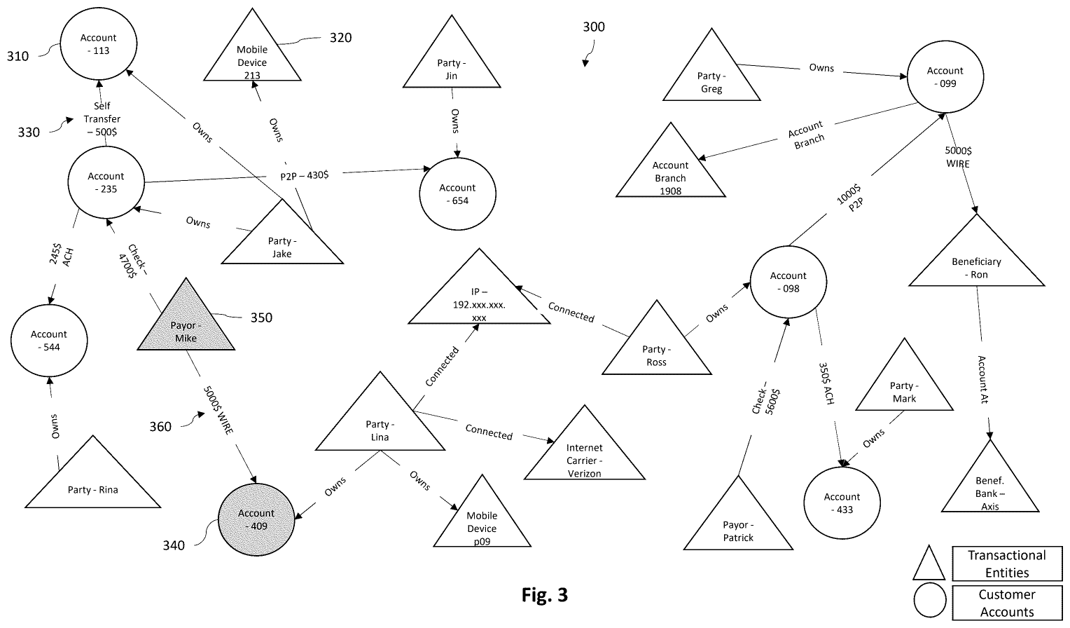

FIG. 3 is a graphical representation of a network 300 of accounts 310, entities 320, and relationships 330 that are associated with an investigated account 340 and investigated entity 350, in accordance with at least one embodiment of the present disclosure. The investigated account 340 and investigated entity 350 may, for example, be associated with a transaction 360 that has triggered the investigation.

When an alert is generated on a suspicious transaction, IFM generates a case for investigation in the risk case manager (RCM) application. The case is assigned to the team of investigators based on the type of alert routing that the financial institution has set up. When an investigator from the team opens an alert for investigation, the alert screen is populated with the network 300 of entities 320 linked with the alerted transactional entities 350. FIG. 3 shows a sample network of entities 320 that may for example be rendered onto the alert screen (e.g., an investigator may see, on the screen, a display similar to FIG. 3).

The shaded customer account 340 (Account—409) and the payor 350 (Mike) are the transactional entities from the current alerted transaction 360. The edge between these 2 nodes represents a wire payment of 500$, originating from Payor Mike to Account 409 owned by Party Lina in the FI.

The network could be computed via a query on the IDB; and may for example be be based on the subject matter expertise of the underlying FI. For the purposes of the present disclosure, the query to construct the network may be the same as used when preparing training data for the link prediction model, as explained below. Alternatively, the FIs who have their data hosted on a graph DB could create the network by writing a query on their graph DB, and could retrieve the network of entities in the alert.

To construct the network 300, the FI could employ a query that involves pulling the following:
The party (FI's customer) holding the account that received the payment in the current transaction. Also, the device (mobile/laptop/tablet), internet service providers, and IP addresses used by the party in the last x days;
Parties (internal to the FI) that were connected to the IP addresses that were accessed by the party in step a (also called second-degree connections). Also, the parties (internal/external to the FI) that paid/were paid to/through these parties, along with their accounts, if the accounts are held in the same FI (also called third-degree connections);
Parties that paid/were paid to/through the parties (internal to the FI) that have third-degree connections to the current transactional entities (fourth-degree connections);
The payor that transferred money to the account in the current transaction;
Other parties (internal/external to the FI) that were paid by the same payor as in the current transaction (second-degree connections), along with their accounts, if the accounts are held in the same FI; and/or
The parties that paid/were paid to/by the parties having second-degree connections to the current transactional entities (indicated as third-degree connections), along with their accounts, if the accounts are held in the same FI.

As described above, the underlying query to fetch the network may require subject-matter-expertise, could be different from one FI to the other, and is governed by multiple factors like the channels through which the FI is facing the large funneling of the fraudulent money, or different banking products used by their customers, etc.

The network 300 is calculated during the detection phase 230 which is shown as a sub-process ‘suspected linked mule accounts collection’ 232 (see FIG. 2), and stored in memory for identifying mule rings. The system 100 collects the accounts present in the network and assess the risk between each pair of accounts using the link prediction model, as described below. The pairs of accounts attaining high-risk scores through the link prediction model are stored in a ‘suspected mule accounts’ table, as described below.

The network 300 of FIG. 3 shows engagement by 8 different accounts 310. The link prediction model predicts the risk between each pair of accounts, (Account 409 & Account 235), (Account 409 & Account 098), etc. Out of all these pairs, if for example the pairs (Account 409 & Account 235) and (Account 235 & Account 099) attained a high-risk score by the link prediction model, the three accounts in these pairs may then be added to the ‘suspected mule accounts’ table.

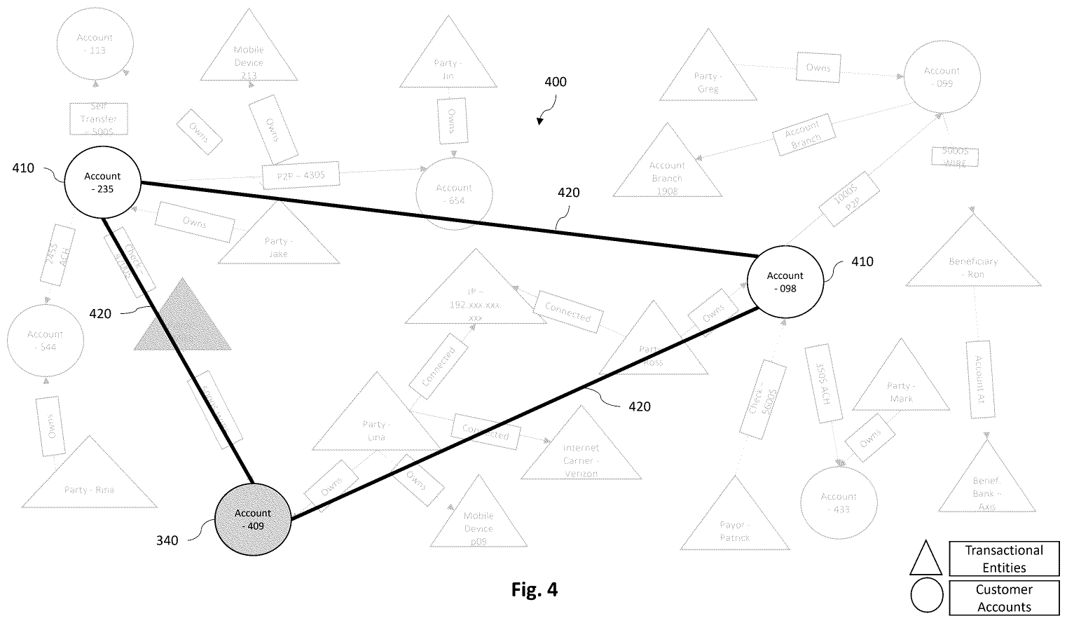

FIG. 4 is a graphical representation of at least a portion of a suspected mule ring 400, in accordance with at least one embodiment of the present disclosure. The investigated account 340 is found to form a high-risk pair 420 with two other accounts 410 in the same network. The two other accounts 410 also form a high-risk pair 420 with one another. Collectively, these accounts 340, 410 form the suspected mule ring 400, the calculation of which is described below.

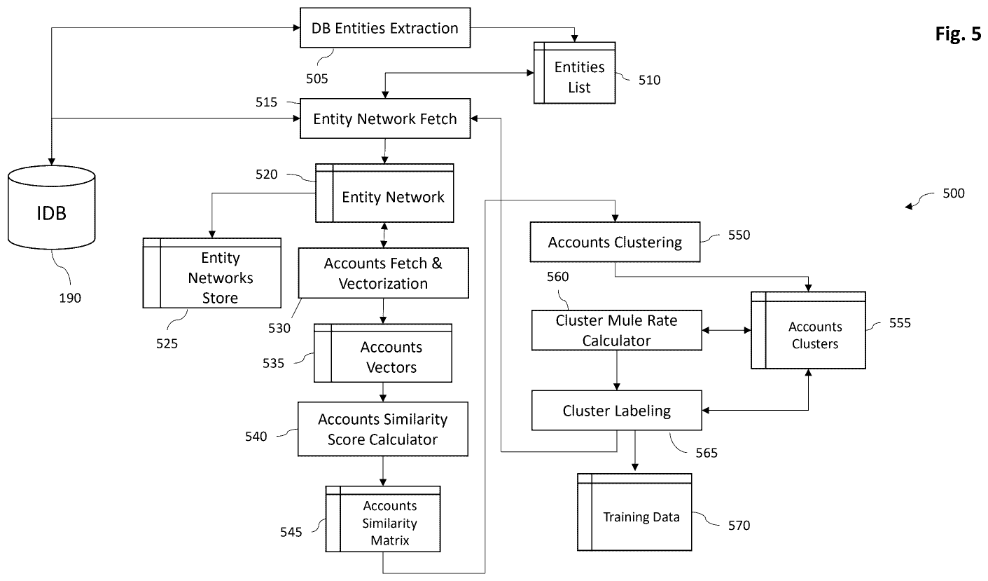

FIG. 5 is a schematic, diagrammatic representation, in block diagram form, of an example training data generation process 500 for a money mule detection system, in accordance with at least one embodiment of the present disclosure. In the example shown in FIG. 5, the training data generation process 500 begins with the investigation database (IDB) 190, which exchanges data with a DB entities extraction block 505 that produces or adds to an entities list 510. The IDB 190 also exchanges data with a network entity fetch block 515, that also exchanges data with the entities list 510. The entity network fetch block 515 produces or adds to the entity network 520, which can be added to the entity networks store 525 for later use. An accounts fetch and vectorization block 530 also exchanges data with the entity network 520, and generates accounts vectors 535 which are received by an accounts score similarity calculator 540 to generate an accounts similarity matrix 545. The accounts similarity matrix 545 is received by an accounts clustering block 530, which produces accounts clusters 555, which are received by a cluster mule rate calculator 560 and cluster labeling block, which organizes the above information into training data 570 before returning to the entity network fetch block 515.

Decisioning on suspected mule accounts can depend on fraud strategy rules. The fraud strategy team of the FI can set up business rules that are evaluated for the transaction under detection, to determine if there exists a mule risk in the current transaction. The ‘suspected mule accounts’ table holds the accounts identified as suspected mules and is linked with the entities in the current transaction. Strategy rules can be set up that utilize this table for automated actions. Following are some examples:
Does the customer account or beneficiary account exist in the suspected mules list?;
Is the number of identified mule accounts in the ‘entity network’ created for the current transaction is greater than 0?;
Is the number of hops/nodes/entities between the customer's account in the current transaction and the nearest mule account less than 2?;
Attached to the above rules could be automated actions, such as delaying and alerting the transaction, challenging the transaction (and requesting information about funds acquired/transferred), or declining the transaction in case of high risk;
High focus list—When the investigator evaluates the risk with the generated alert, which is associated with one or multiple mule accounts, as identified by the link prediction model, he/she can choose to put the accounts in a high-focus list. Next time, in case any activity happens over these accounts, or if these accounts are part of the ‘entity network’ that the money mule detection system generates for the transaction, those transactions can be alerted/declined/challenged. An indication that there exists a high-focus suspected mule account in the ‘entity network’, for instance, can be used in the risk scoring ML model, or can be used in a strategy rule;
Training the mule link prediction model;
The mule link prediction model may for example be a classification ML model such as a binary classifier. Training the ML model involves historical data and labels from the FI, that help identify known mule accounts. The link prediction model is trained on data points that define a relation between a pair of accounts, in the form of a numeric vector (e.g., the accounts vectors 535). This is different from the usual strategy for training a binary classification model, where in a model is trained on transactional information, for instance;
Training data collection; and/or
Fetching entity networks in the lab.

FIG. 5 depicts the steps performed while collecting data for training the link prediction model. As discussed above, the model is trained on relation information between 2 pairs of accounts. These accounts, forming the pair, are part of a network/clique/graph. The relation information that is drawn for model training comes from the account pairs from multiple networks.

Fetching or generating the network begins with determining the set of entities that have a link (whether direct or indirect) to a mule account (e.g., an account labeled as a known mule by the FI). The ‘DB entities extraction’ module 505 corresponds to collecting transactional entities that are linked to a mule account. The link to the mule account could be via direct transfer received/sent to the mule account, device sharing, IP address sharing, etc.

The collected entities are stored in the ‘Entities List’ 510. The money mule detection system loops through each entity in the list and fetches records that include entities linked to the entity, n hops away, within time period t in history, and meet pre-determined filtering criteria (e.g., as defined by the FI). The number of hops corresponds to the n-degree connections that will be pulled to construct the network; and may for example be defined by the FI based on their expertise. The ‘entity network fetch’ block 515 fetches the records that include linked entities, from IDB 190, that are linked to the underlying entity in the current loop. The indication of whether the account entity is a mule or not is also fetched alongside, as ‘mule_indicator’.

Fetching the network begins with defining a query, either on a relational database, big-data repository, or a graph DB, to pull the network of entities. In an example, the query is structured on the following rules:
Identify payors who paid to an account that was classified as a mule by the FI in the last 12 months;
For each identified payor, pull all the accounts that were paid by the payor, along with their disposition information (mule/not-mule) as shared by the FI. These are second-degree connections to the mule account;
For each identified account in the second-degree connections, pull the accounts that were paid through these accounts, or were paid to these accounts, along with their disposition information (mule/not-mule) as shared by the FI. These are third-degree connections to the mule account; and/or
Note that the above is a query formulated based on a specific pattern witnessed among the reported mule accounts by an FI. However, the example is non-limiting.

The returned records containing entities and links between entities (e.g., via transaction records), are stored as ‘Entity Network’ 520 if the distinct number of accounts in the network is greater than or equal to ‘min_accounts_per_network’, else the system drops the network and continue building the network for the next entity in the loop. This process continues for each entity, and the networks (if that have enough accounts) are saved in the ‘Entity Networks Store’ 525. The ‘Entity Network’ 520 is stored in ‘Entity Networks Store’ 525 along with the linking/seed entity.

Below is a sample ‘Entity Network’. Note that the records in the network may contain risk features like expert features for mule risk identification, which are mined through party/account profiles by the money mule detection system when the record's transaction was processed.

TABLE 1
Example Entity Network

| transaction_key | transaction_date | payor_id | account_id | beneficiary_id | . . . | mule_indicator |
|---|---|---|---|---|---|---|
| asf292dsifk | 2023-05-21 19:23 | John_134 | Mike981 | | . . . | 0 |
| dksadajgfj2 | 2023-05-22 01:30 | | Jade001 | Rina_099 | . . . | 0 |
| . . . | . . . | . . . | . . . | . . . | . . . | . . . |
| dsa99jdd2d | 2023-06-15 21:00 | Kevin_329 | Ron134 | | . . . | 1 |

Note that in the example shown, the account_id is the unique ID of the account held at the FI. The payor_id and beneficiary_id are the unique IDs of entities that may/may not be part of the FI, and uniquely identify the entity paying to the account, or was paid by the account, held in the FI, respectively.

Now, for each ‘Entity Network’, the following steps 1 to 3 are performed.

### Step 1—Vectorization of Accounts in the Entity Network:

Individual networks are handled one by one. From each network, the system pulls the distinct accounts and creates a numeric vector to represent these accounts. The numeric vector is calculated by pulling the mule risk features from the latest record of the account in the network. The examples of mule risk features could be—

Indication of ‘check deposit’ followed by ‘self-transfers’ to different accounts held by the customer in the same FI.

Number of distinct payors and beneficiaries that the customer interacted with in the last 30 days.

Days since the account opened to the current transaction date.

The predictive features pulled for each account are then used to represent the accounts in the form of a numeric vector. For an account A in the network, the mule risk features are vectorized to represent account A in the following form—

F_{A}={F₁,F₂, . . . ,F_{N}},

Where F₁ . . . F_{N} are the mule risk feature values, including the vector F_{A}.

In addition to mule risk features, the vector is extended to include features from the ‘Entity Network’. The features of the network could for example include the following—

Number. of entities interacting with the account.

Min./Max. number of hops from the linking/seed entity.

The account IDs and corresponding vectors are stored in ‘Accounts Vectors’ 535.

### Step 2—Determining Similarity Between Accounts in a Network:

The next step is to find the similarity between each pair of accounts in ‘Accounts Vectors’ 535. In an example, the system uses the numeric vector that represents accounts, and cosine similarity as the distance measure to calculate the similarity between each pair of accounts in the table. Other calculations may be used instead or in addition.

In an example, cosine similarity between customer account A and customer account B is calculated using the numeric vector for each account as below—

$$cosine ( {F}_{A} , {F}_{B} ) = ( {F}_{A} \cdot {F}_{B} ) / ( ‖ {F}_{A} ‖ \cdot ‖ {F}_{B} ‖ ) \qquad ( EQN 1 )$$

When cosine (F_{A}, F_{B})=1, two vectors are identical, or accounts A and B are completely similar. The cosine similarity may for example be a score between 0 and 1 that shows how similar the two accounts are with 0 being not at all similar and 1 signifying completely similar. The cosine similarity scores between each pair of accounts are stored in the form of a matrix, as the ‘Similarity Matrix’ 545.

### Account Vector

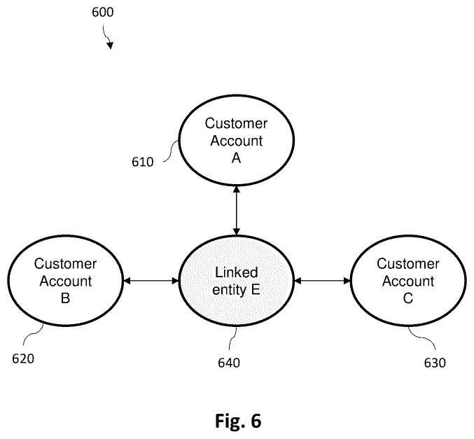

Consider a network including of 3 different customer accounts connected via linked entity (as shown below in FIG. 6)

Account vector for a customer account ‘A’, linked with an entity ‘e’ in a network, is calculated as—

F_{A}={Features from party/account profile_{A}} Union {Features from the network}

F_{A}={f_{A1},f_{A2}, . . . ,f_{An}}, where

[f_{A1}, f_{A2}, . . . , f_{An}] are n features that are pulled from the profile maintained for account ‘A’ or the party holding the account ‘A’, and the features from the network.

TABLE 2
Example Accounts Vectors

| account_id | vector |
|---|---|
| John234 | [21.0, 890.4, . . . , 1] |
| Mike982 | [456.0, 98.1, . . . , 0] |
| . . . | . . . |
| Ron098 | [9.0, 12.3, . . . , 1] |

### Step 3—Clustering Accounts in a Network:

The matrix data is fed to a clustering algorithm 550 (e.g., a k-means algorithm, although other algorithms may be used instead or in addition), to cluster together the accounts based on their cosine similarity between all other n−1 accounts, where n is the no. of accounts in the network. While using k-means, the default distance metrics (e.g., the Euclidean distance) can be used to measure the distance between data points (similarity scores) and calculate centroids.

In an example, having 4 clusters 555 on average for each ‘Entity Network’ 520 is good for efficient clustering. In other examples, the number of clusters may be between 2 and 6, although other numbers both larger and smaller may be used instead or in addition.

The clustered accounts are then stored in the ‘Accounts Clusters’ 555 with the following information—

The linking/seed entity of the ‘Entity Network’. This is used to uniquely identify the network.

### Account Identifier.

Cluster ID—a unique ID to identify clusters within/across all ‘Entity Network’.

The cluster mule rate calculation block 560 calculates the mule account rate of each cluster in the ‘Accounts Clusters’ 555. The ‘mule_indicator’ attribute fetched from IDB 190 for each account in ‘Entity Network’ 520 is used for this purpose. Using this indicator, the percentage of mule accounts over the total number of accounts in each cluster is calculated. If the mule party rate for a given cluster is above 50%, for instance, the other non-mule accounts in the cluster are considered mule accounts as well. This is done because these accounts exhibit similar characteristics as the reported mule accounts and most probably have missed being reported by the FI because of a lack of enough evidence for successful reporting.

The clusters are then labeled, such that the clusters with a high mule account rate may be labeled with ‘1’ and the rest as ‘0’, in the ‘Accounts Clusters’ 555, and stored in column ‘Cluster label’. The ‘Accounts Clusters’ 555 are then added to a training dataset or pre-training dataset table, ‘Training Data’ 570.

FIG. 6 is a graphical representation of an accounts cluster 600, in accordance with at least one embodiment of the present disclosure. The cluster 600 includes a linked entity 640 (e.g., an account or individual associated with an alerted transaction), along with three customer accounts 610, 620, and 630 that are linked with the linked entity 640 (e.g., that are in the same network) and that share similar characteristics with the linked entity 640, such that they appear in the same cluster.

### Relation Features Vector

### Relation Features Vector is Defined as a Function Between Vectors of Customer Account A and Customer Account B

$$R ( {F}_{A} , {F}_{B} ) = f ( {F}_{A} \cdot {F}_{B} ) \qquad ( EQN . 2 )$$

Where, f(FA. FB) is a function of two account vectors. For e.g, the difference of 2 account vectors.

Consider below 2 account vectors, representing accounts A & B—

F_{A}−[1,100,23,99]

F_{B}−[0,200,20,90]

Where each vector is includes of 4 mule risk and/or network features.

Then, the relation feature vector can be defined as a function of FA and FB, e.g.,

$$R ( {F}_{A} , {F}_{B} ) = f ( {F}_{A} \cdot {F}_{B} ) = {F}_{A} - {F}_{B} \qquad ( EQN . 3 )$$

$$R ( {F}_{A} , {F}_{B} ) = [ 1 , 100 , 23 , 99 ] - [ 0 , 200 , 20 , 90 ] \qquad ( EQN . 4 )$$

$$R ( {F}_{A} , {F}_{B} ) = [ 1 , - 100 , 3 , 9 ] \qquad ( EQN . 5 )$$

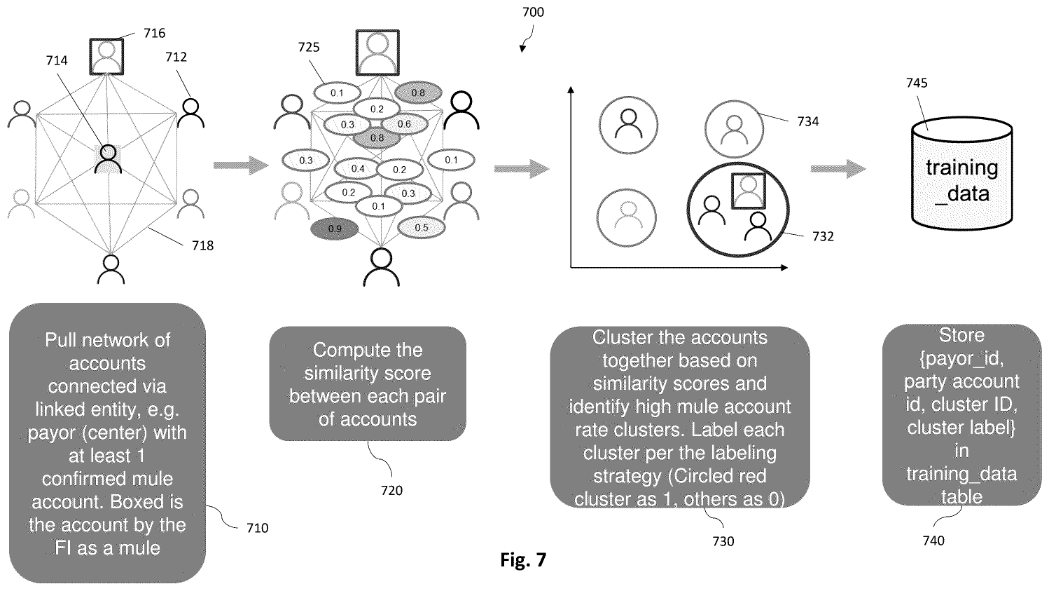

FIG. 7 is a schematic, diagrammatic representation, in flow diagram form, of an example money mule detection system training data creation method 700, in accordance with at least one embodiment of the present disclosure. It is understood that the steps of method 700 may be performed in a different order than shown in FIG. 7, additional steps can be provided before, during, and after the steps, and/or some of the steps described can be replaced or eliminated in other embodiments. One or more of steps of the method 700 can be carried by one or more devices and/or systems described herein, such as components of the system 100, application server 140, risk case manager system 145, and/or processor circuit 1750.

In step 710, the method 700 includes pulling a network of accounts 712 that are connected via a linked entity 714, such as a payor, where the network includes at least one confirmed mule account 716 (e.g., as identified by the FI). Execution then proceeds to step 720.

In step 720, the method 700 includes computing a similarity score 725 between each pair of accounts 718. Execution then proceeds to step 730.

In step 730, the method 700 includes clustering the accounts together based on their similarity scores, and identifying high mule account rate clusters (e.g., those clusters which contain a high proportion of mule accounts). In an example, this involves labeling high mule rate clusters 732 with a “1”. And non-high-mule-rate clusters 734 with a “0”. Execution then proceeds to step 740.

In step 740, the method 700 includes storing the labeled data for each account (e.g., payor ID, party account ID, cluster ID, and cluster label) in the training data 745. The method 700 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, creating the training data may involve analyzing thousands of accounts. In inference mode, results from the machine learning network may need to be returned within 1-2 seconds to avoid a sensation of lag or latency on the part of the fraud investigator.

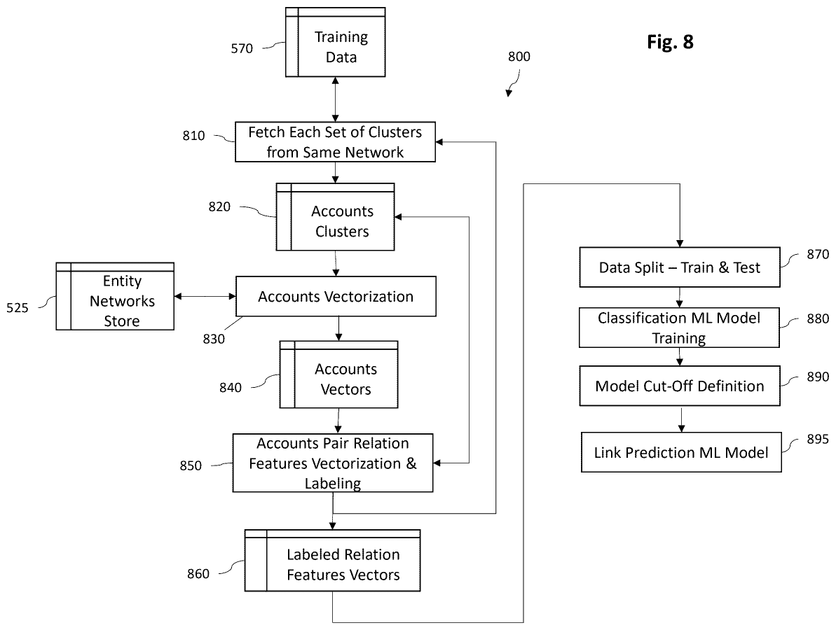

FIG. 8 is a schematic, diagrammatic representation, in block diagram form, of an example money mule identification system machine learning model training process 800, in accordance with at least one embodiment of the present disclosure. The training process 800 begins with training data 570, which is received by a cluster fetching step 810 that fetches each set of clusters from the same network. These accounts clusters 820 are then vectorized in a vectorization step 840 and stored in both the entity networks store 525 and the accounts vectors 840. The accounts vectors 840 are then received by a step 850 in which accounts pair relation features are vectorized and labeled. These labeled relation features vectors 860 are then received by a step 870 in which the data is split and used to train and test the ML model 880, which is evaluated against cutoff definitions or rules 890. When sufficient prediction accuracy has been achieved, the ML model 880 becomes the trained link prediction ML model 895.

The training data 570 is queried for the ‘Account Clusters’ 820 from each network. For each cluster of accounts that are queried, the following steps are performed.

Each account is represented in a vector form using mule risk features. The feature values can be pulled from the latest record for the account in the ‘Entity Network’. The mule risk features that are pulled at this point could be the same/different/additional to the features used for cosine similarity calculation in FIG. 5. The ‘Entity Networks Store’ 525 is queried for the ‘Entity Network’ using the linking/seed entity ID with which the account clusters were stored in ‘Training Data’ 570.

Here again, features from the ‘Entity Network’ can also be added to the account's features vector.

The list of features (mule risk features from the profile, and network features) names are stored in the ‘Features List’, as explained below.

The account vectors are stored in ‘Accounts Vectors’ 840.

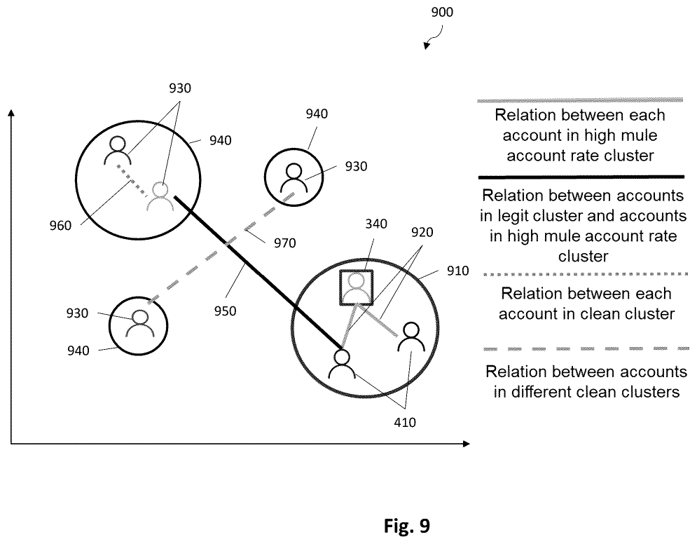

FIG. 9 is a graphical representation 900 of account clusters and edges between accounts in a network, in accordance with at least one embodiment of the present disclosure. The graphical representation includes a high mule rate cluster 910 and three legitimate clusters 940. The high mule rate cluster 910 includes a known mule account 340 and two similar accounts 410 that are linked by relationships 920 that are suspected mule relationships. Legitimate accounts 930 within a legitimate cluster 940 are linked by relationships 960 that are not suspected to be mule relationships. Similarly, legitimate accounts 930 in two different legitimate clusters 930 within the same network are linked by relationships 970 that are not suspected of being mule relationships.

Relationships 950 between an account 410 in a high mule account rate cluster 910 and an account 930 in a legitimate cluster may not be suspected of being mule relationships, but may nevertheless be flagged for additional scrutiny in future transactions.

This graphical representation 900 describes how the relation features vector is created. A relation between a pair of accounts is a function of the vectors of both accounts in the pair. For instance, the system can define the function to be the difference in the respective feature values from the 2 vectors. The relation features vector R(F_{A}, F_{B}), between accounts A & B, is stored in the ‘Relation Features Vectors’ table, as shown below.

There exist 4 types of edges/relations between the accounts in a network, as depicted in these graphics:

Edge 920 between a pair of accounts that lie in the same mule cluster.

Edge 960 between a pair of accounts that lie in the same non-mule cluster.

Edge 950 between a pair of accounts, out of which one lies in a mule cluster and the other lies in a non-mule cluster.

Edge 970 between pair of accounts, wherein neither the accounts are part of a mule cluster nor they are part of the same cluster.

These edges are represented in FIG. 9 as relation feature vectors in vectorized form. numerical vectors are then used to train the link prediction model. However, the system needs labels to train a binary classification model. Hence, these edges/vectors are labeled. For this purpose, the system may for example label each edge between a pair of accounts that lie in the same mule cluster, as 1/positive, and all other 3 edges as 0/negative. This is done to ensure that the model learns to efficiently distinguish a pair of accounts that are both, suspected mules and similar to each other and are thus part of a possible fraud mule ring.

Based on the above strategy, the label for each relation features vector is updated in ‘Relation Features Vectors’.

The labeled relation feature vectors in ‘Relation Features Vectors’ are then used for training an ML model (e.g., a binary classification model, although other types may be used instead or in addition). In an example, an XGBoost model can be used, although the implementor of this disclosure is free to use the model of their choice. Each vector has feature values (e.g., categorical or numeric) which serve as data points for training the model.

Each edge between pair of accounts is represented as a Relation features vector,

$$R ( {F}_{A} , {F}_{B} ) = f ( {F}_{A} \cdot {F}_{B} ) \qquad ( EQN . 6 )$$

$$Let ,$$

$${R}_{x} = f ( {F}_{A} x , {F}_{B} x ) \qquad ( EQN . 7 )$$

where Account A and B are accounts connected with the edge. ‘x’ is the analytics feature representing account behavior. If ‘x’ represents the number of credits for the account, then—

Rₓ=Difference between no. of credits by Account A and Account B

Each vector in ‘Relation Features Vectors’ is of size n, where n is the number of features in the account vectors that were used to calculate the relation features vectors. The index value of each vector is pulled and considered as an individual column. So, for instance, given each relation features vectors in the table in the below form—

TABLE 3
Example Relation Features Vectors Table

| relation_features_vector | label |
|---|---|
| [12.5, 98.1, . . . , 2] | 0 |
| [1, −80, . . . , −1] | 1 |
| . . . | . . . |
| [87, 0, . . . , 12] | 1 |

Where each vector is of size n, it is converted to a data set for training as shown below.

TABLE 4
Example Training Data

| vector_index_1 | vector_index_2 | . . . | vector_index_n | label |
|---|---|---|---|---|
| 12.5 | 98.1 | | 2 | 0 |
| 1 | −80 | | −1 | 1 |
| . . . | . . . | . . . | . . . | . . . |
| 87 | 0 | | 12 | 1 |

Where vector_index_[1 . . . n] are the predictors/features that will be used for training the link prediction model, and vector_index_x, is a function of a feature at index ‘x’ in ‘Features List’, whose value is pulled from both account vectors in pair on which the relation features vector was defined.

The vectors are split into training, validation, and test sets. The model is trained using the training set, and the best model (among different models with different hyperparameters) is chosen (e.g., through k-fold validation) on the validation set. The chosen model is tested for performance on the test set or other suitable data.

The model generates a probability score for an edge/relation, similar to the ones it is trained on, and hence there is a need to define a cut-off score for identifying suspicious mule account pairs. The model is packaged along with the ‘Features List’, and deployed to the production system.

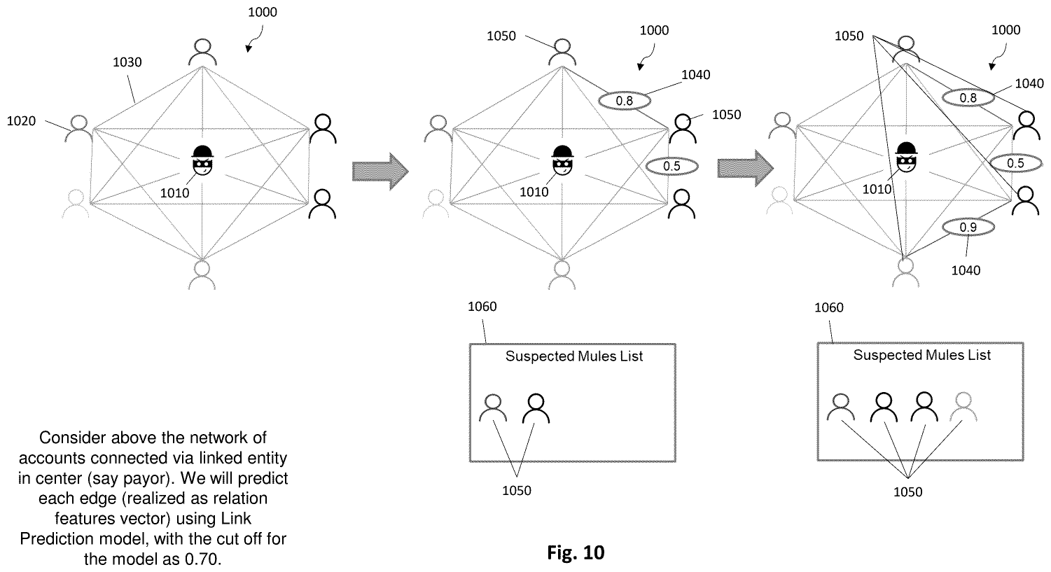

FIG. 10 is a graphical representation of the use of the link prediction machine language model in inference mode, in accordance with at least one embodiment of the present disclosure. When an entity (e.g., a payor 1010 in an alerted transaction) is investigated, the money mule detection system calculates the network 1000 of entities or accounts 1020 that are within n hops of the payor 1010.

In the example shown in FIG. 10, the labeled relation feature vectors have been used to for training a binary classification ML model (e.g., an XGBoost model, although other model types may be used instead or in addition). The model is then used to predict values 1040 for each edge 1030, indicating the probability that the edge represents a mule relationship. If the prediction 1040 for an edge 1030 exceeds a threshold value (e.g., 0.7, on a scale of 0 to 1, with 1 indicating the highest probability), then the two accounts or entities 1020 linked by that edge 1030 are classified as suspected mules 1050, and are placed on a suspected mules list 1060. The suspected mules list 1060 may then be reported to the user, used in further training of the ML model, and/or added to business rules that trigger the operation of the money mule detection system in inference mode.

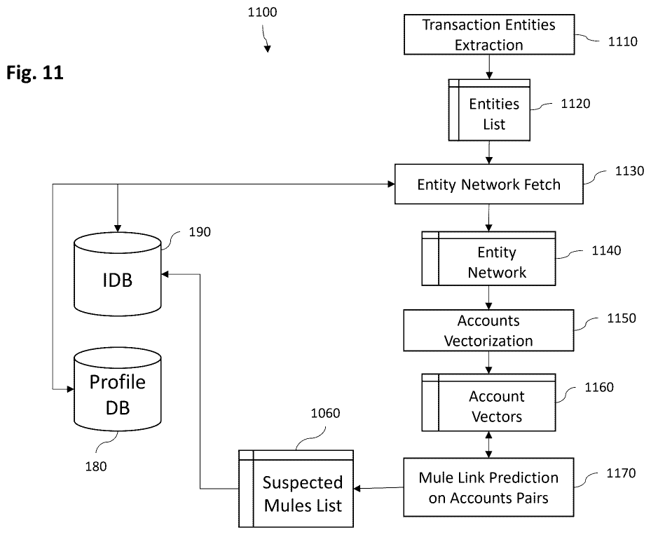

FIG. 11 is a schematic, diagrammatic representation, in block diagram form, of an example inference mode 1100 of the money mule detection system, in accordance with at least one embodiment of the present disclosure. A transaction entities extraction step 1110 yields an entities list 1120 that is received by an entity network fetch step 1130 that exchanges data with the profile DB 180 and IDB 190 to produce the entity network 1140. The accounts in the network 1140 are then vectorized in a vectorization step 1150, yielding account vectors 1160. The account vectors 1160 are then fed to the link prediction ML model to perform a mule link prediction step 1170 on the account pairs within the network. Pairs with a high predicted mule risk score are then added to the suspected mule list 1060, which is incorporated into the IDB 190 for future use.

In an example, a beneficiary ‘Mike’ is the current investigated entity, and the system pulls all the accounts that are 2 hops away from the current entity. The query for constructing the network may then include all the customer accounts in the FI who paid to or were paid by Mike in the last x days. These can be regarded as first-degree connections to Mike and are 1 hop away from Mike. All customer accounts that paid into or were paid by those accounts then become second-degree connections that are 2 hops away from Mike.

Based on subject matter expertise, the implementor of this disclosure could decide to employ additional constraints on the querying criteria depending on the relevance of the entities, data volume, etc. The returned records are stored as the ‘Entity Network’.

For each account in ‘Entity Network’, the system pulls the mule risk features from the profile DB, to represent each account as a numeric vector. Note that here, differently from the way the ‘Entity Network’ was created in training mode, the mule risk feature values may be pulled from profile DB 180, and not from the IDB 190. The mule risk features that are pulled from the profile may be the same that are used for accounts vectorization when developing the link prediction model. The implementor of this disclosure could choose to implement an API with an ML model as a container that returns the ‘Features List’ that should be used for accounts' vectorization. Alternatively, these can be configured in a file that can be read by the IFM detection process.

Here again, the features from the ‘Entity Network’ can be used to extend the features vector that represents the account. The account IDs and corresponding vectors are stored in ‘Accounts Vectors’. The system pulls each pair of accounts A & B, from ‘Accounts Vectors’, and creates a relation features vector using the account vector pairs, as described above.

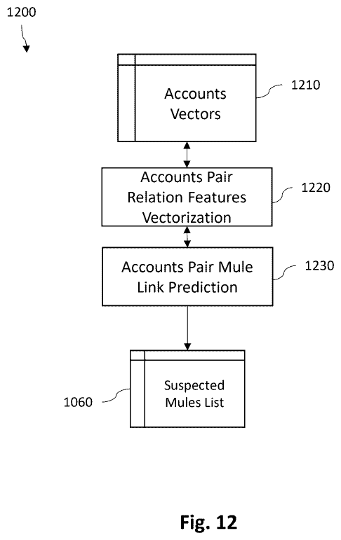

FIG. 12 is a schematic, diagrammatic representation, in block diagram form, of an example inference mode 1200 of the money mule detection system, in accordance with at least one embodiment of the present disclosure. FIG. 12 shows how the link prediction model predicts a mule risk score for the edge between each pair of accounts in the input list of accounts formulating the network.

The relation features vector is evaluated using the link prediction model. If the score returned by the model is greater than the pre-determined cut-off (e.g., 0.7), then the associated account IDs A & B are added to the ‘Suspected Mules’ list. The feature values from the account vectors for A & B are also stored, along with account IDs.

The ‘Suspected Mules’ table is persisted in the IDB so that it can be rendered in the generated alert. Also, the table data can be used by the risk-scoring ML model as a feature, which can be passed to the model an indication of whether the current account is determined as a mule by the link prediction model, or the number of mule accounts in the network, etc.

In the example shown in FIG. 12, the account vectors 1210 are vectorized in an accounts pair features vectorization step 1220, and the link prediction ML model then performs a link prediction step 1230 on each account pair in the current network. Pairs with a link production (e.g., mule risk) score above the threshold value (e.g., 0.7) are added to the suspected mules list 1060.

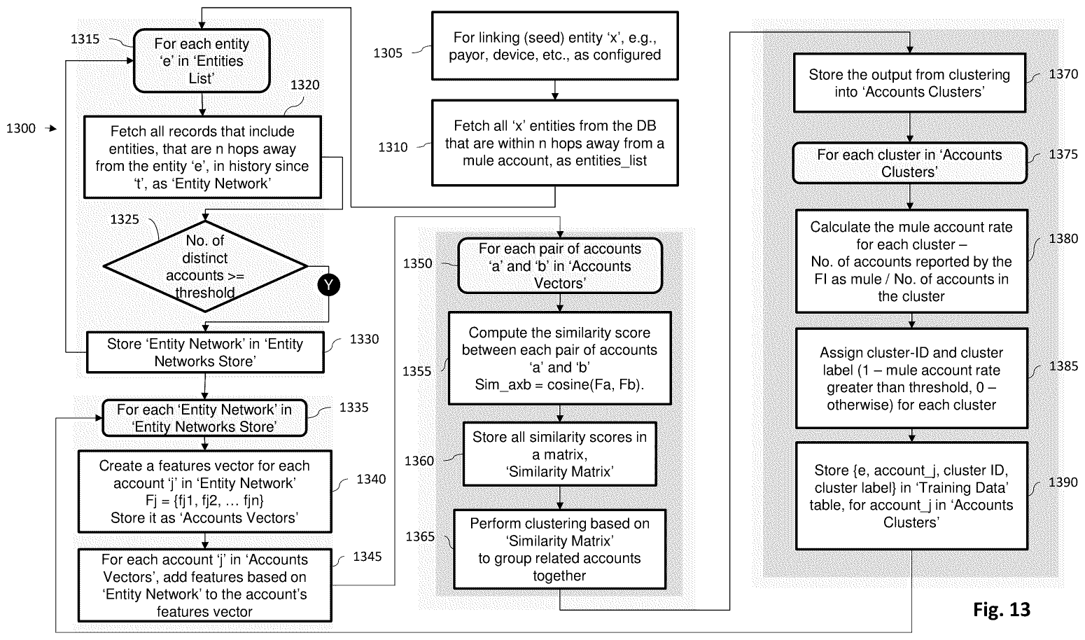

FIG. 13 is a schematic, diagrammatic representation, in flow diagram form, of an example money mule detection method 1300, in accordance with at least one embodiment of the present disclosure.

### Network Creation (Data Preparation)

In step 1305, the method 1300 includes initialization of variables, such as:

Define linking (seed entity) type, e.g., payor, beneficiary, device id, as ‘e’.

Define the lookback period, as ‘t’.

Define the num_hops.

Define additional filter criteria, as ‘filter_criteria’.

Execution then proceeds to step 1310.

In step 1310, the method 1300 includes fetching the distinct linking entity from the database where the entity has a link to a mule account that is within num_hops away from the entity, within time-period ‘t’ from the current date, and satisfy ‘filter_criteria’, and store them as ‘Entities List’. Execution then proceeds to step 1315.

In step 1315, the method 1300 includes initiating a loop: For each entity ‘e’ in the ‘Entities List’. For each hop in [1 . . . num_hops]. Execution then continues to step 1320.

In step 1320, the method 1300 includes fetching the records from the database that include entities (including accounts plus ‘mule_indicator’ flag), that are linked to ‘e’, within time-period ‘t’ from the current date and satisfy ‘filter_criteria’. Store all the records as the ‘Entity Network’. Store all the distinct entities in ‘Entity Network’ along with the type, as ‘entities_list_with_type’. Execution then continues to step 1325.

In step 1325, the method 1300 includes determining whether the number of distinct accounts in the network is greater than a threshold number (e.g., greater than three). If no, the method is complete. If yes, then execution proceeds to step 1330.

In step 1330, the method 1300 includes storing the entity network in the entity networks store. Execution then returns to step 1315 until the loop is complete, and then proceeds to step 1335.

In step 1335, the method 1300 includes initiating a loop for each entity network in the entity networks store. Execution then proceeds to step 1340.

In step 1340, the method 1300 includes creating a features vector for each account ‘j’ in ‘Entity Network’ Fj={fj1, fj2, . . . fjn} and storing it as ‘Accounts Vectors’. Execution then proceeds to step 1345.

In step 1345, the method 1300 includes, for each account ‘j’ in ‘Accounts Vectors’, adding features based on ‘Entity Network’ to the account's features vector. Execution then proceeds to step 1350.

In step 1350, the method 1300 includes initiating a loop for each pair of accounts “a” and “b” in “accounts vectors”. Execution then proceeds to step 1355.

In step 1355, the method 1300 includes computing the similarity score between each pair of accounts ‘a’ and ‘b’, as Sim_axb=cosine(Fa, Fb). Execution then proceeds to step 1360.

In step 1360, the method 1300 includes storing all similarity scores in a matrix, ‘Similarity Matrix’. Execution then proceeds to step 1365.

In step 1365, the method 1300 includes performing clustering based on ‘Similarity Matrix’ to group related accounts together. Execution then proceeds to step 1370.

In step 1370, the method 1300 includes storing the output from the clustering into ‘Accounts Clusters’. Execution then proceeds to step 1375.

In step 1375, the method 1300 includes, for each cluster in “Accounts Clusters”, performing steps 1380-1390.

In step 1380, the method 1300 includes calculating the mule account rate for each cluster as the number of accounts reported by the FI as mule/number of accounts in the cluster. Execution then proceeds to step 1385.

In step 1385, the method 1300 includes assigning a cluster-ID and cluster label (1—mule account rate greater than threshold, 0—otherwise) for each cluster. Execution then proceeds to step 1390.

In step 1390, the method 1300 includes storing {e, account_j, cluster ID, cluster label} in the ‘Training Data’ table, for account_j in ‘Accounts Clusters’. Execution then returns to step 1335 until the loop is complete. When the loop is complete, the method 1300 is complete.

TABLE 5
Example Entities List

entity_id
Lina_123
Pattrick_099
. . .
Ross_345

The entity network list contains the values for the defined entity type, like payor, beneficiary, device_id, etc., that are queried from the database and will serve as the linking (seed) entity for the network creation.

TABLE 6
Entity Network

| Linking_entity | linking_entity_type | Transaction_key | transaction_date | payor_id | Account_id | Beneficiary_id | . . . | mule_indicator |
|---|---|---|---|---|---|---|---|---|
| John_134 | payor_id | asf292dsifk | 2023-05-21 19:23 | John_134 | Mike981 | | . . . | 0 |
| John_134 | payor_id | dksadajgfj2 | 2023-05-22 01:30 | | Jade001 | Rina_099 | . . . | 0 |
| . . . | . . . | . . . | . . . | . . . | . . . | . . . | . . . | . . . |
| John_134 | payor_id | dsa99jdd2d | 2023-06-15 21:00 | Kevin_329 | Ron134 | | . . . | 1 |

The entity network is the set of records pulled from the database using a linking/seed entity that includes connection information with other entities in the network, that are n hops away from the linking entity, within period t in history, and qualifying filtering criteria (if defined). The data elements to be pulled in the entity network should be defined by the implementor of this disclosure based on the subject matter expertise.

The entity network contains the linking_entity and linking_entity_type, which are used to identify the originating source of the network. So, for instance, to identify in the above table the shortest path from account ‘Ron134’ to the linking entity, e.g., ‘John_134’, then the system can use, for instance, Dijkstra's algorithm to find the shortest path between the 2 entities in the entity network. This measure can then be used in account vectorization, for instance.

TABLE 7
Example Entity Networks Store

| Linking_entity | Linking_entity_type | Transaction_key | transaction_date | payor_id | Account_id | Beneficiary_id | . . . | mule_indicator |
|---|---|---|---|---|---|---|---|---|
| John_134 | payor_id | asf292dsifk | 2023-05-21 19:23 | John_134 | Mike981 | | . . . | 0 |
| John_134 | payor_id | dksadajgfj2 | 2023-05-22 01:30 | | Jade001 | Rina_099 | . . . | 0 |
| . . . | . . . | . . . | . . . | . . . | . . . | . . . | . . . | . . . |
| Merry_680 | payor_id | 9ds2jfs9sj2 | 2023-06-15 21:00 | Laura_090 | Karen111 | | . . . | 1 |

The entity networks store is a collection of all entity networks. Once the entity networks are pulled, they are stored in the entity networks store (if they exceed the minimum number of accounts in the network criteria), so that each entity network can be pulled and operated upon for later steps.

Here again, the linking_entity and linking_entity_type uniquely identifies an entity network in the store, and can be used to pull an entity network from the store.

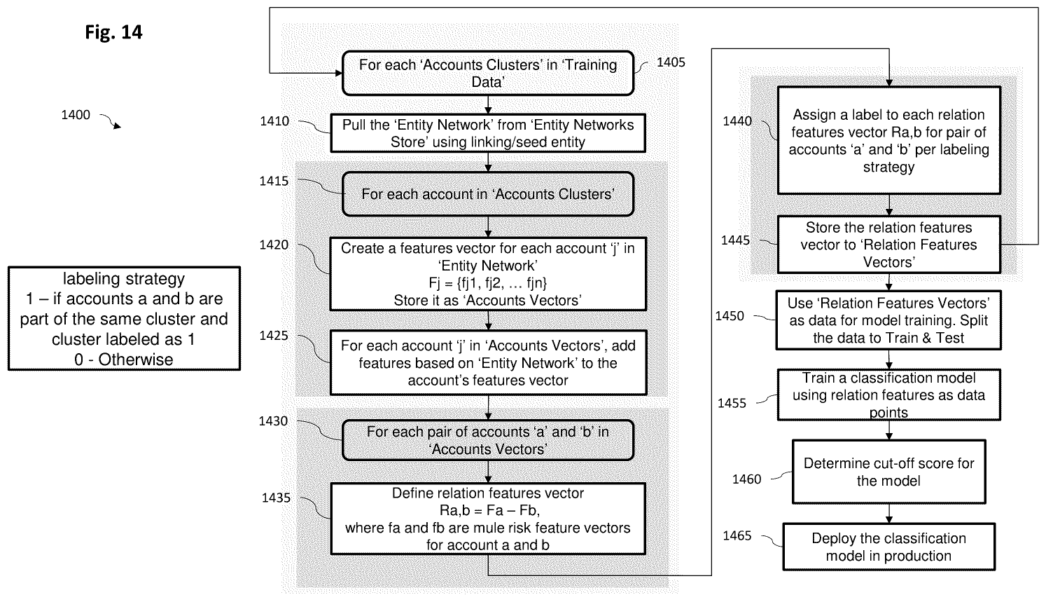

FIG. 14 is a schematic, diagrammatic representation, in flow diagram form, of an example money mule detection method 1400, in accordance with at least one embodiment of the present disclosure.

In step 1405, the method 1400 includes initiating a loop: for each “account clusters” in “Training Data”, perform steps 1410-1445.

In step 1410, the method 1400 includes pulling the ‘Entity Network’ from ‘Entity Networks Store’ using the linking/seed entity. Execution then proceeds to step 1415.

In step 1415, the method 1400 includes initiating a loop: for each account in “account clusters”, performing steps 1420 to 1425. Execution then proceeds to step 1420.

In step 1420, the method 1400 includes creating a features vector for each account ‘j’ in ‘Entity Network’ Fj={fj1, fj2, . . . fjn} and storing it in ‘Accounts Vectors’. Execution then proceeds to step 1425.

In step 1425, the method 1400 includes, for each account ‘j’ in ‘Accounts Vectors’, adding features based on ‘Entity Network’ to the account's features vector. Execution then proceeds to step 1430.

In step 1430, the method 1400 includes initiating a loop: for each pair of accounts ‘a’ and ‘b’ in ‘Accounts Vectors’, perform steps 14435 to 1445. Execution then proceeds to step 1435.

In step 1435, the method 1400 includes defining relation features vector Ra,b=Fa−Fb, where fa and fb are mule risk feature vectors for account a and b. Execution then proceeds to step 1440.

In step 1440, the method 1400 includes assigning a label to each relation features vector Ra,b for pair of accounts ‘a’ and ‘b’ per the labeling strategy (1 if both accounts belong to a high-mule cluster, 0 if otherwise). Execution then proceeds to step 1445.

In step 1445, the method 1400 includes storing the relation features vector to ‘Relation Features Vectors’. Execution then proceeds to step 1450.

In step 1450, the method 1400 includes using ‘Relation Features Vectors’ as data for model training, splitting the data to Train & Test segments. Execution then proceeds to step 1455.

In step 1455, the method 1400 includes training a classification model using relation features as data points. Execution then proceeds to step 1460.

In step 1460, the method 1400 includes determining a cut-off score for the model, to determine whether the model has achieved the desired level of accuracy. Execution then proceeds to step 1465.

In step 1465, the method 1400 includes deploying the classification model in production (e.g., in the risk case manager system 145 of FIG. 1). The method 1400 is now complete.

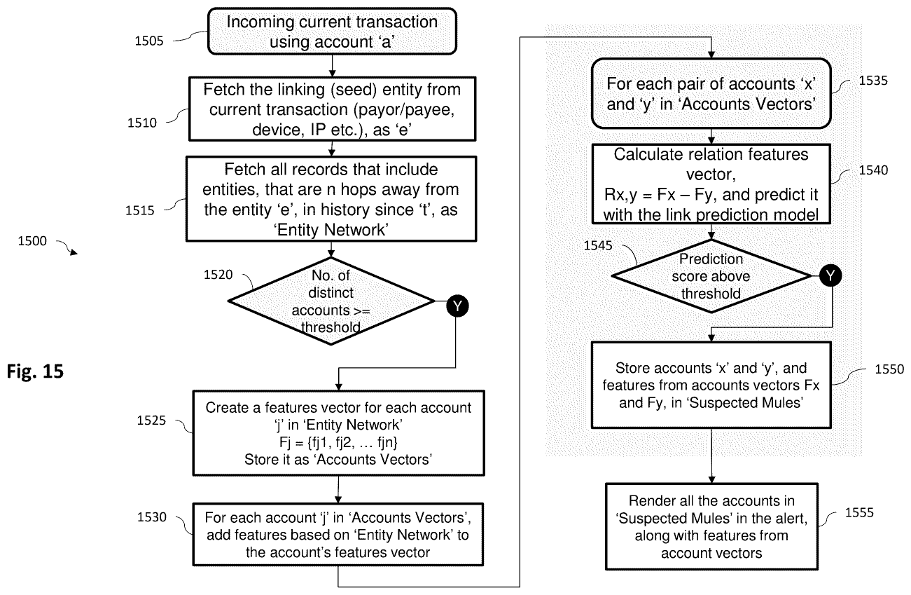

FIG. 15 is a schematic, diagrammatic representation, in flow diagram form, of an example money mule detection method 1500, in accordance with at least one embodiment of the present disclosure.

In step 1505, the method 1500 includes receiving an incoming current transaction that is using account ‘a’. Execution then proceeds to step 1510.

In step 1510, the method 1500 includes fetching the linking (seed) entity from the current transaction (e.g., a payor/payee, device, IP etc.), as ‘e’. Execution then proceeds to step 1515.

In step 1515, the method 1500 includes fetching all records that include entities, that are n hops away from the entity ‘e’, in history since ‘t’, as ‘Entity Network’. Execution then proceeds to step 1520.

In step 1520, the method 1500 includes determining whether the number of distinct accounts in the network exceeds a threshold number (e.g., 5 accounts). If no, the method 1500 is complete. If yes, execution then proceeds to step 1525.

In step 1525, the method 1500 includes creating a features vector for each account ‘j’ in ‘Entity Network’ Fj={fj1, fj2, . . . fjn} and storing it in ‘Accounts Vectors’. Execution then proceeds to step 1530.

In step 1530, the method 1500 includes, for each account ‘j’ in ‘Accounts Vectors’, adding features based on ‘Entity Network’ to the account's features vector. Execution then proceeds to step 1535.

In step 1535, the method 1500 includes initiating a loop: for each pair of accounts ‘x’ and ‘y’ in ‘Accounts Vectors’, executing steps 1540-1550.

In step 1540, the method 1500 includes calculating a relation features vector,

Rx,y=Fx−Fy, and predicting its mule risk with the link prediction model. Execution then proceeds to step 1545.

In step 1545, the method 1500 includes determining whether the predicted mule risk is above the threshold (e.g., 0.7). If no, the loop is now complete. If yes, execution then proceeds to step 1550.

In step 1550, the method 1500 includes storing accounts ‘x’ and ‘y’, and features from accounts vectors Fx and Fy, in ‘Suspected Mules”. Execution then proceeds to step 1555.

In step 1555, the method 1500 includes rendering all the accounts in ‘Suspected Mules’ in the alert, along with features from account vectors. The method 1500 is now complete.

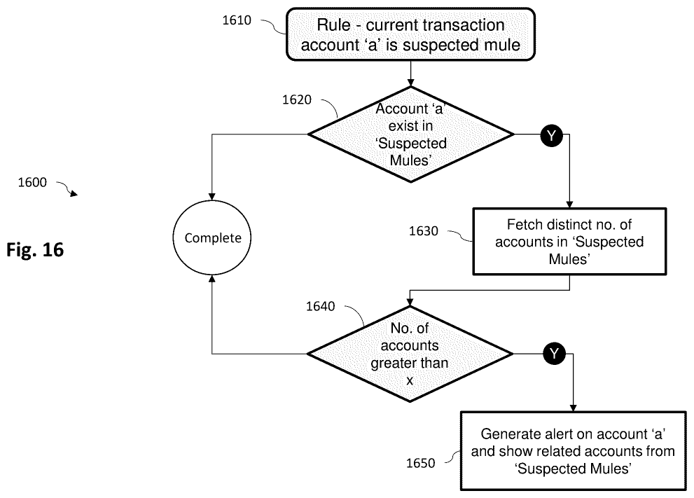

FIG. 16 is a schematic, diagrammatic representation, in flow diagram form, of an example money mule detection method 1600, in accordance with at least one embodiment of the present disclosure.

In step 1610, the method 1600 includes determining (e.g., based on a rule) that the current transaction account “a” is a suspected mule account. Execution then proceeds to step 1620.

In step 1620, the method 1600 includes determining whether account “a” appears in the suspected mules list. If no, the method 1600 is complete. If yes, execution then proceeds to step 1630.

In step 1630, the method 1600 includes fetching a distinct number of accounts from the suspected mules list, e.g., all of the accounts in the list. The reference here is to a business rule that checks in the network generated for the current transaction undergoing detection, if the current account is identified as a mule (e.g., is present in the list), then check how many mule accounts are identified in total. Execution then proceeds to step 1640.

In step 1640, the method 1600 includes determining whether the number of fetched accounts is greater than a threshold number “x”. If no, the method is complete. If yes, execution proceeds to step 1650.

In step 1650, the method 1600 includes generating an alert on account “a” and showing related accounts from the suspected mules list. The method 1600 is now complete. In an example, the similarity matrix table contains the following—
account_id—unique id of the account

vector—numeric vector where each index contains a mule risk feature value, like account available balance, no. of credits on the account, etc. Or a feature extracted from the network, like the number of connections that the account has in the network.

TABLE 8
Example Similarity Matrix

account_id

| account_id | John234 | Mike982 | . . . | Ron098 |
|---|---|---|---|---|
| John234 | 1 | 0.9 | . . . | 0.3 |
| Mike982 | 0.1 | 1 | . . . | 0.7 |
| . . . | . . . | . . . | . . . | . . . |
| Ron098 | 0.4 | 0.2 | . . . | 1 |

The above matrix is of size N×N where N is the number of accounts in the network. The matrix contains the similarity score between each pair of accounts. The similarity score is calculated for example using the cosine similarity distance measure, where the similarity score is a value between 0 and 1.

TABLE 9
Example Accounts Clusters

| linking_entity | account_id | cluster_id | cluster_label |
|---|---|---|---|
| Merry_090 | John234 | 231 | 1 |
| Merry_090 | Mike982 | 231 | 1 |
| . . . | . . . | . . . | . . . |
| Merry_090 | Catheline142 | 234 | 0 |

Each account in each network is assigned to a cluster (clustering at network level). The above table holds the following data elements—
linking_entity—the seed/linking entity that was used to fetch the network
account_id—the unique ID of the account
cluster_id—the unique ID of the cluster
cluster_label—the cluster label (I/O)

The above table holds the exemplary clusters formed for single entity network's accounts.

TABLE 10
Example Training Data

| linking_entity | account_id | cluster_id | cluster_label |
|---|---|---|---|
| Merry_090 | John234 | 231 | 1 |
| Merry_090 | Mike982 | 231 | 1 |
| . . . | . . . | . . . | . . . |
| Jerry_346 | Ron098 | 345 | 0 |

In an example, all the account clusters are stored in the training data table. The linking_entity uniquely identifies the clusters belonging to same network, and using this each network's clusters are pulled for later processing.

TABLE 11
Example Relation Features Vectors

| relation_features_vector | label |
|---|---|
| [12.5, 98.1, . . . 2] | 0 |
| [1, −80, . . . , −1] | 1 |
| . . . | . . . |
| [87, 0, . . . , 12] | 1 |

The table contains—

relation_features_vector—vector output from a function that transforms the vectors of the given account pairs. The size of each vector is same.

label-identifies whether the given account pair are part of same cluster with high mule party rate (1), or not (0).

TABLE 12
Features List

Features
Feature_1
Feature_2
. . .
Features_n

The list contains the features, Features_[1 . . . n], including the account vectors, e.g., mule risk features or network features. The list is packaged along with the link prediction ML model so as to allow the system to infer the list of features that need to be used to construct the account vectors, which is used for relation features vectors creation, when detecting mule risk in real-time transaction.

TABLE 13
Example Suspected Mules List

| account_id | feature_1 | feature_2 | . . . | feature_n |
|---|---|---|---|---|
| John234 | 21.0 | 890.4 | . . . | 1 |
| Mike982 | 456.0 | 98.1 | | 0 |
| . . . | . . . | . . . | . . . | . . . |
| Ron098 | 9.0 | 12.3 | . . . | 1 |

The table contains the account_id of the accounts, identified in pairs as mule account pairs by the link prediction model. Along with it, the features that were used for the account vectorization are included in the table for rendering onto the alert. The features_[1 . . . n] are the features that includes the vector that represents the account.

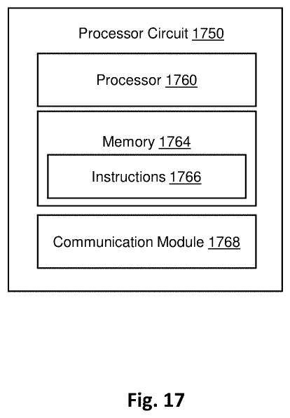

FIG. 17 is a schematic diagram of a processor circuit 1750, in accordance with at least one embodiment of the present disclosure. The processor circuit 1750 may be implemented in the system 100, server 110, server 140, IFM boxes 130, database server 150, or other devices or workstations (e.g., third-party workstations, network routers, etc.), or on a cloud processor or other remote processing unit, as necessary to implement the method. As shown, the processor circuit 1750 may include a processor 1760, a memory 1764, and a communication module 1768. These elements may be in direct or indirect communication with each other, for example via one or more buses.

The processor 1760 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1760 may also include another hardware device, a firmware device, or any combination thereof configured to perform the operations described herein. The processor 1760 may also be implemented as a combination of computing devices, e.g., a combination of a DSP and a microprocessor, a plurality of microprocessors, one or more microprocessors in conjunction with a DSP core, or any other such configuration.

The memory 1764 may include a cache memory (e.g., a cache memory of the processor 1760), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1764 includes a non-transitory computer-readable medium. The memory 1764 may store instructions 1766. The instructions 1766 may include instructions that, when executed by the processor 1760, cause the processor 1760 to perform the operations described herein. Instructions 1766 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1768 can include any electronic circuitry and/or logic circuitry to facilitate direct or indirect communication of data between the processor circuit 1750, and other processors or devices. In that regard, the communication module 1768 can be an input/output (I/O) device. In some instances, the communication module 1768 facilitates direct or indirect communication between various elements of the processor circuit 1750 and/or the system 100. The communication module 1768 may communicate within the processor circuit 1750 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or otherwise) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

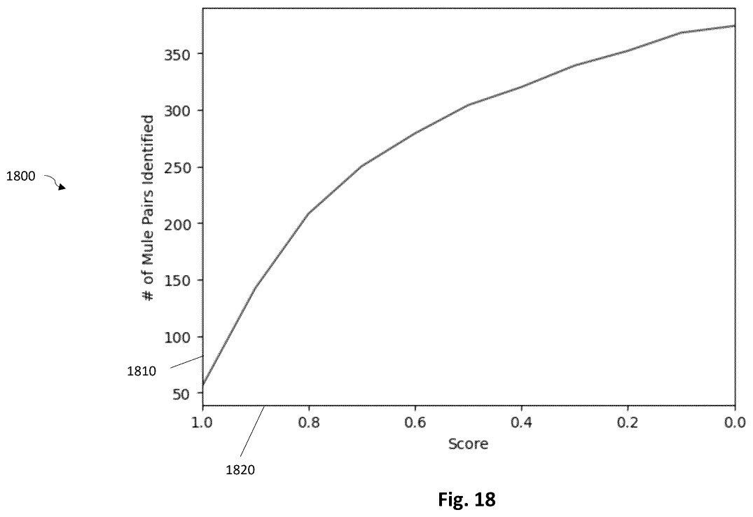

FIG. 18 is a graph 1800 showing the number of mule pairs detected 1810 as a function of the risk score cutoff 1820, in accordance with at least one embodiment of the present disclosure. In the example shown in FIG. 18, out of 374 mule connections in the test data, the trained money mule detection system is able to detect approximately 279 when the mule risk score cutoff is set at 0.5, and is able to detect approximately 255 when the mule risk score cutoff is set to 0.7. In the example shown in FIG. 18, there are 8515 non-mule pairs in the test data, so the number of false positives at various risk score cutoffs is shown below in Table 14.

TABLE 14
False Positives

| Risk Score Cutoff | False Positives |
|---|---|
| 0.9 | 1 |
| 0.7 | 10 |
| 0.5 | 28 |
| 0.2 | 133 |
| 0.0 | 8515 |

As will be readily appreciated by those having ordinary skill in the art after becoming familiar with the teachings herein, the money mule detection system provides a novel means for creating and training a machine learning network to detect mule accounts, that is not well known or understood in the existing art. Accordingly, it can be seen that the money mule detection system fills a long-standing need in the art, by providing a trained link prediction ML model that can, in real time, identify suspected mule accounts linked to a potentially suspicious entity, account, or event that is under investigation. The system provides high accuracy, e.g., in excess of 95% true positive and less than 5% false positive.

A number of variations are possible on the examples and embodiments described above. For example, different kinds of machine learning models can be used for the link prediction, including but not limited to logistic regression, random forest, or support vector machine models. Networks may be formed from any number of hops, from one to several dozen. The linked entity, seed entity, or transaction entity may be a sending account, a receiving account, a device, an internet protocol (IP) address, a bank branch, a physical address, a sending email, a receiving email, a phone number, a sending person's name, a receiving person's name, etc.

Similarity may be computed by other means than cosine similarity, including but not limited to Jaccard similarity, Euclidian distance, or Manhattan distance. The accounts vectorization may involve any number of features, from one to several dozen. Features may for example include the account overdraft limit, whether the current payor is old for the party, a number of credits, a ratio of the current deposit amount to the previous deposit amount, a number of deposits on the account, a number of transfers following the deposit, a rounded amount in the latest check, a number of payors in the last 30 days, a number of payors, a rounded number of transfers, a channel of the latest deposit, a number of fractional credits, a number of new accounts, a number of old accounts, an account type, a rounded number of credits, a number of payors new to the FI, an account opening channel code, a number of beneficiaries in the past 30 days, a number of payee banks, a number of beneficiaries, a latest deposit week of the month, whether the current payor is old for the FI, a latest deposit hour of the day, or an account number of a related parties. Other features may be used instead or in addition.

The technology described herein may be applied not only to anti-money-laundering (AML) applications, but to any situation where mule accounts bay be used to move money.

Accordingly, the logical operations making up the embodiments of the technology described herein are referred to variously as operations, blocks, steps, objects, elements, components, or modules. Furthermore, it should be understood that these may be occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the money mule detection system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the money mule detection system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically identify suspected mule accounts, the system comprising:
a processor and a non-transitory computer readable medium operably coupled thereto, the computer readable medium comprising a plurality of instructions stored in association therewith that are accessible to, and executable by, the processor, to perform operations which comprise:
from a plurality of entity types associated with a financial institution, selecting a seed entity type and collecting a plurality of entities of the selected type associated with the financial institution;
for each collected entity, considered as a seed entity, from the plurality of entities:
identifying a first network of accounts associated with the seed entity, m transaction hops away from the seed entity, and looking at period t in history;
if the first network of accounts includes at least one mule account, storing the network;
for each network that is stored:
computing a similarity score between each pair of accounts in the first network of accounts;
based on the similarity scores, clustering the accounts into n clusters;
for each cluster:
determining a ratio of known mule accounts in the cluster to a total number of accounts in the cluster;
if the ratio exceeds a mule account rate threshold value;
creating a label identifying the cluster as a mule account cluster;
if the ratio does not exceed the mule account rate threshold value; creating the label identifying the cluster as a non-mule account cluster;
storing the seed entity, the accounts, cluster ID, and the label, into a pre-training dataset;
using the pre-training dataset to define a relation between each pair of accounts in the network;
labeling each relation between account pairs as either part of a mule ring or not part of a mule ring;
with the account pairs and the labels, training a link prediction model using supervised machine learning; and
in real time:
receiving a transaction in a fraud management system for a transaction entity of the plurality of entities associated with the financial institution;
identifying a second network of accounts associated with the transaction entity, m transactions hops away from the transaction entity, and looking at period t in history;
with the link prediction model, for each pair of accounts in the second network of accounts:
computing a link prediction score, representative of a likelihood that the accounts in the pair of accounts are mule accounts;
if the link prediction score exceeds a second threshold value, adding the accounts in the pair of accounts to a suspected mules list; and
displaying the suspected mules list to a user.

2. The system of claim 1, wherein n is at least 2 and no greater than 6, and wherein m is at least 2 and no greater than 6.

3. The system of claim 1, wherein the mule account rate threshold value is at least 50%.

4. The system of claim 1, wherein the threshold score for the link prediction machine learning model is at least 70%.

5. The system of claim 1, wherein the seed entity is a sending account, a receiving account, a device, an internet protocol (IP) address, a bank branch, a physical address, a sending email, a receiving email, a phone number, a sending person's name, or a receiving person's name.

6. The system of claim 1, wherein the transaction entity is a sending account, a receiving account, a device, an internet protocol (IP) address, or a bank branch.

7. The system of claim 1, wherein m is at least 2 and no greater than 4

8. The system of claim 1, wherein t is at least 6 months and no greater than 12 months.

9. The system of claim 1, wherein criteria for identifying the first network and criteria for identifying the second network are the same.

10. A computer-implemented method for automatically identifying suspected mule accounts, the method comprising:
with a processor and a non-transitory computer readable medium operably coupled thereto:
from a plurality of entity types associated with a financial institution, selecting a seed entity type and collecting a plurality of entities of the selected type associated with the financial institution;
for each collected entity, considered as a seed entity, from the plurality of entities:
identifying a first network of accounts associated with the seed entity, m transaction hops away from the seed entity, and looking at period t in history;
if the first network of accounts includes at least one mule account, storing the network;
for each network that is stored:
computing a similarity score between each pair of accounts in the first network of accounts;
based on the similarity scores, clustering the accounts into n clusters;
for each cluster:
determining a ratio of known mule accounts in the cluster to a total number of accounts in the cluster;
if the ratio exceeds a mule account rate threshold value;
creating a label identifying the cluster as a mule account cluster;
if the ratio does not exceed the mule account rate threshold value; creating the label identifying the cluster as a non-mule account cluster;
storing the seed entity, the accounts, cluster ID, and the label, into a pre-training dataset;
using the pre-training dataset to define a relation between each pair of accounts in the network;
labeling each relation between account pairs as either part of a mule ring or not part of a mule ring;
with the account pairs and the labels, training a link prediction model using supervised machine learning; and
in real time:
receiving a transaction in a fraud management system for a transaction entity of the plurality of entities associated with the financial institution;
identifying a second network of accounts associated with the transaction entity, m transactions hops away from the transaction entity, and looking at period t in history;
with the link prediction model, for each pair of accounts in the second network of accounts:
computing a link prediction score, representative of a likelihood that the accounts in the pair of accounts are mule accounts;
if the link prediction score exceeds a second threshold value, adding the accounts in the pair of accounts to a suspected mules list; and
displaying the suspected mules list to a user.

11. The method of claim 10, wherein n is at least 2 and no greater than 6, and wherein m is at least 2 and no greater than 6.

12. The method of claim 10, wherein the mule account rate threshold value is at least 50%.

13. The method of claim 10, wherein the threshold score for the link prediction machine learning model is at least 70%.

14. The method of claim 10, wherein the seed entity is a sending account, a receiving account, a device, an internet protocol (IP) address, a bank branch, a physical address, a sending email, a receiving email, a phone number, a sending person's name, or a receiving person's name.

15. The method of claim 10, wherein the transaction entity is a sending account, a receiving account, a device, an internet protocol (IP) address, or a bank branch.

16. The method of claim 10, wherein m is at least 2 and no greater than 4

17. The method of claim 10, wherein t is at least 6 months and no greater than 12 months.

18. The method of claim 10, wherein criteria for identifying the first network and criteria for identifying the second network are the same.
